(19) United States
(12) Patent Application Publication
(10) Pub. No.: US 2024/0101763 A1
(43) Pub. Date: Mar. 28, 2024

(54) COMPOSITION COMPRISING ORGANIC FUNCTIONAL ALKOXYSILANES AND COATING COMPOSITIONS COMPRISING THE SAME

(71) Applicant: Momentive Performance Materials Inc., Waterford, NY (US)

(72) Inventors: Alok SARKAR, Bangalore (IN); Bhanu PRATAP, Bihar (IN); Yogesh TIWARY, Bengaluru (IN); Antonio CHAVES, Chappaqua, NY (US); Eric POHL, Mount Kisco, NY (US)

(21) Appl. No.: 18/274,510

(22) PCT Filed: Feb. 1, 2022
(86) PCT No.: PCT/US2022/014692

§ 371 Date: Jul. 27, 2023

(30) Foreign Application Priority Data
Feb. 2, 2021 (IN) 202121004497

(51) Int. Cl. C08G 77/18; C08J 5/18; C09D 5/02; C09D 183/06; C09J 183/06; C09K 3/10

(52) U.S. Cl. CPC C08G 77/18; C08J 5/18; C09D 5/022; C09D 183/06; C09J 183/06; C09K 3/1018; C08J 2383/06; C09K 2200/0685

(57) ABSTRACT

An organic functional silane composition is shown and described herein. An organic functional silane composition comprises a mixture of organic functional silane monomers where at least one of the silane monomers comprises two or more alkoxy groups having C1-C2 alkyl groups and at least one of the silane monomers comprises two or more alkoxy groups having an alkyl group of three or more carbon atoms. The organic functional silane compositions can be employed in a coating composition and can improve one or more properties of the coating including, for example, scrub resistance.

### CROSS-REFERENCE TO RELATED APPLICATIONS

The present application claims priority to and the benefit of India Patent Registration Provisional Application 202121004497, filed on Feb. 2, 2021, the disclosure of which is incorporated herein by reference in its entirety.

### FIELD OF INVENTION

The present invention relates to a composition comprising two or more organic functional alkoxysilanes and coating compositions comprising such organic functional alkoxysilane compositions. In particular, the present invention relates to a composition comprising a mixture of organic functional alkoxysilanes having lower carbon alkoxy groups and organic functional alkoxysilanes having higher carbon alkoxy groups. In embodiments, the organic functional alkoxysilane compositions are suitable for use as an additive in coating compositions such as, for example, in paint compositions.

### BACKGROUND

Functional alkoxy silanes are often used in paint formulations. Functional alkoxy silanes may provide enhanced performance in terms of adhesion, corrosion resistance, hydrophobicity, scrub resistance, chemical resistance, etc. Functional alkoxy silanes are generally used in combination with other polymers/binders (film formers). These can be used with or without fillers or pigments. In some instances, scrub resistance can be improved by using a binder having functional groups that can react with the organic functional groups of the alkoxy silane with a filler that can react with the alkoxy or silanol groups of the silane. While not being bound to any particular theory, this may be due to improved coupling between the binder and the filler. Adhesion may also be improved since the silanol end of the silane can interact with the substrate to which the coating is applied.

One issue with using monomeric alkoxy silanes in water is their sensitivity to hydrolysis and condensation which is difficult to control. This can lead to decreased performance over time or after storage. Thus, while initial performance such as scrub resistance may be improved with the use of functional alkoxy silanes, performance properties such as scrub resistance can significantly decrease over a short period of time.

Some attempts to improve the properties of coatings have focused on employing alkoxy silane oligomers as an alternative to the use alkoxy silane monomers. U.S. Pat. Nos. 6,391,999, 7,595,372, 8,728,345, and 10,196,407, for example, describe compositions employing epoxy silane oligomers. Such compositions may improve various aspects of the coating. There still, however, is an interest in improving a property such as scrub resistance after storage of the composition.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a composition suitable for use as an additive in a coating composition. The composition comprises a mixture of two or more organic functional alkoxysilanes. The composition is useful in a coating composition, such as, for example, a paint composition. The organic functional alkoxysilane compositions can improve the scrub resistance of a coating composition.

In one aspect, provided is a composition comprising two or more organic functional functional alkoxysilanes where at least one of the organic functional alkoxysilanes has an alkoxy functional group with three or more carbon atoms. In one embodiment, the composition comprises an organic functional alkoxysilane comprising one or more lower carbon alkoxy groups (e.g., methoxy and/or ethoxy) and an organic functional alkoxysilane comprising one or more higher carbon alkoxy groups (e.g., alkoxy groups with hydrocarbons having three or more carbon atoms).

In one aspect, provided is a coating composition comprising a film forming material and the organic functional alkoxysilane composition with the mixture of organic functional alkoxysilanes. The use of the composition with the mixture of organic functional alkoxysilanes can improve the scrub resistance of a coating formed from such coating compositions. This improvement can be found even after storage of the composition over periods of time.

In one aspect, provided is an organic functional silane composition comprising: an organic functional alkoxy silane monomer or oligomer having one or more alkoxy groups wherein the alkoxy group contains 1-2 carbon atoms; and an organic functional silane monomer or oligomer having one or more alkoxy groups wherein the alkoxy groups contains 3 or more carbon atoms.

In one embodiment, the organic functional silane composition comprising (i) two or more organic functional silane monomers is selected from monomers (a)-(d); (ii) an oligomer of one or more monomers selected from monomers (a)-(d); or (iii) a mixture of (i) and (ii), where monomers (a)-(d) are selected from:
(a) a silane of the formula (I):

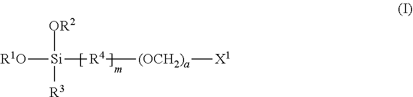

where R¹ and R² are each independently chosen from a monovalent C1-C2 hydrocarbon; R³ is a C1-C10 alkyl or —OR⁵, where R⁵ is a C1-C2 hydrocarbon; R⁴ is a C2-C60 divalent hydrocarbon; m is an integer between 0 or 1; and a is 0 or 1;
(b) a silane of the formula (II):

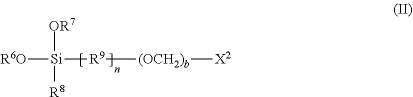

where R⁶ is chosen from a monovalent C1-C2 hydrocarbon; R⁷ is a C3-C20 monovalent hydrocarbon; R⁸ is a C1-C10 alkyl or —OR¹⁰, where R¹⁰ is a C1-C2 hydrocarbon R⁹ is a divalent C2-C60 hydrocarbon; n is an integer between 0 or 1; and b is 0 or 1;
(c) a silane of the formula (III):

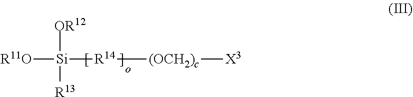

where R¹¹ and R¹² are each independently chosen from a monovalent C3-C20 hydrocarbon; R¹³ is a C1-C10 alkyl or —OR⁵, R⁵ is a monovalent C1-C2 hydrocarbon; R¹⁴ is a divalent C2-C60 hydrocarbon; o is an integer between 0 or 1; and c is 0 or 1; and
(d) a silane of the formula (IV):

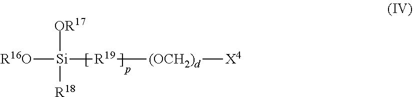

where R¹⁶, R¹⁷, and R¹⁸ are each independently selected from a monovalent C3-C20 hydrocarbon; R¹⁹ is selected from a divalent C2-C60 hydrocarbon; p is an integer between 0 or 1; and d is 0 or 1; and
X¹, X², X³, and X⁴ are each independently an organic functional group functional group.

In one embodiment, the organic functional silane composition comprises silane (a) and silane (b) or an oligomer thereof.

In one embodiment, the organic functional silane composition comprises silane (a) and silane (c) or an oligomer thereof.

In one embodiment, the organic functional silane composition comprises silane (a) and silane (d) or an oligomer thereof.

In one embodiment, the organic functional silane composition comprises silane (b) and silane (c) or an oligomer thereof.

In one embodiment, the organic functional silane composition comprises silane (b) and silane (d) or an oligomer thereof.

In one embodiment, the organic functional silane composition comprises silane (c) and silane (d) or an oligomer thereof.

In one embodiment, the organic functional silane composition comprises silane (a), silane (b), and silane (c) or an oligomer thereof.

In one embodiment, the organic functional silane composition comprises silane (a), silane (b), and silane (d) or an oligomer thereof.

In one embodiment, the organic functional silane composition comprises silane (a), silane (c), and silane (d) or an oligomer thereof.

In one embodiment, the organic functional silane composition comprises a silane (b), silane (c), and silane (d) or an oligomer thereof.

In one embodiment, the organic functional silane composition comprises a mixture or oligomer of silane (a), silane (b), silane (c), and silane (d) or an oligomer thereof.

In one embodiment in accordance with any of the previous embodiments, the organic functional silane composition is a mixture of two or more oligomers of one or more of silanes (a)-(d).

In one embodiment in accordance with any of the previous embodiments, the organic functional silane composition comprises (i) one or more silanes of (a)-(d), and (ii) an oligomer of one or more of silanes (a)-(d).

In one embodiment in accordance with any of the previous embodiments, the organic functional silane composition wherein R³ is —OR⁵; R⁸ is —OR¹⁰; and R¹³ is —OR¹⁵.

In one embodiment in accordance with any of the previous embodiments, the organic functional silane composition wherein X¹, X², X³, and X⁴ are independently selected from an alkyl group, an aromatic group, an alicyclic group, an alkenyl group, an amino group, an acrylic, an acryloxy group, an amide group, a mercapto group, a cyano group, a hydroxyl group, or an epoxy group.

In one embodiment in accordance with any of the previous embodiments, the organic functional silane composition wherein X¹, X², X³, and X⁴ are independently selected from an epoxy group.

In one embodiment in accordance with any of the previous embodiments, the organic functional silane composition wherein X¹, X², X³, and X⁴ are independently selected from:

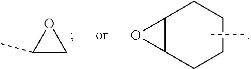

In one embodiment in accordance with any of the previous embodiments, X¹, X², X³, and X⁴ are independently selected from a C2-C20 alkenyl group.

In one embodiment in accordance with any of the previous embodiments the alkenyl group is a vinyl group, and a, b, c, d, m, n, o, and p are each 0.

In one embodiment in accordance with any of the previous embodiments, (i) X¹, X², X³, and X⁴ are each vinyl and a, b, c, d, m, n, o, and p are each 0; (ii) X¹, X², X³, and X⁴ are each amine group and m, n, o, and p are each 1, R⁴, R⁹, R¹⁴, and R¹⁹ are each a C3 hydrocarbon, and a, b, c, and d are each 0; (iii) X¹, X², X³, and X⁴ are each cyano group and m, n, o, and p are each 1, R⁴, R⁹, R¹⁴, and R¹⁹ are each a C3 hydrocarbon, and a, b, c, and d are each 0; (iv) X¹, X², X³, and X⁴ are each thiol group and m, n, o, and p are each 1, R⁴, R⁹, R¹⁴, and R¹⁹ are each a C3 hydrocarbon, and a, b, c, and d are each 0; (v) X¹, X², X³, and X⁴ are each acryloxy group and m, n, o, and p are each 1, R⁴, R⁹, R¹⁴, and R¹⁹ are each a C3 hydrocarbon, and a, b, c, and d are each 0; (vi) X¹, X², X³, and X⁴ are each acrylamido group and m, n, o, and p are each 1, R⁴, R⁹, R¹⁴, and R¹⁹ are each a C3 hydrocarbon, and a, b, c, and d are each 0.

In another aspect, provided is a copolymer of the organic functional silane composition of any of the previous embodiments, and a monomer or a functional polymer.

In another aspect, provided is an emulsion comprising the silane composition of or copolymer in accordance with any of the previous embodiments.

In still another aspect, provided is a coating, adhesive, or sealant composition comprising the silane composition in accordance with any of the previous embodiments.

In one embodiment, the coating, adhesive, or sealant consists essentially of the silane composition in accordance with any of the previous embodiments.

In one embodiment, the coating, adhesive, or sealant composition is a waterborne composition.

In one embodiment, the coating, adhesive, or sealant composition is a solvent borne composition.

In one embodiment, the coating, adhesive, or sealant is an emulsion

In a further aspect, provided is a substrate coated with the composition in accordance with any of the previous embodiments.

In still another further aspect, provided is a process for synthesizing an oligomer, the process comprising reacting at least two silanes selected from the group consisting of a silane having the formula (a), a silane having formula (b), a silane having formula(c), and a silane having formula (d) or their oligomers
(a) a silane of the formula (I):

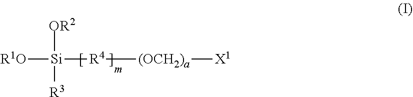

where R¹ and R² are each independently chosen from a monovalent C1-C2 hydrocarbon; R³ is a C1-C10 alkyl or —OR⁵, where R⁵ is a C1-C2 hydrocarbon; R⁴ is a C2-C60 divalent hydrocarbon; m is an integer between 0 or 1; and a is 0 or 1;
(b) a silane of the formula (II):

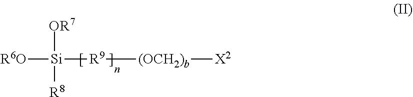

where R⁶ is chosen from a monovalent C1-C2 hydrocarbon; R⁷ is a C3-C20 monovalent hydrocarbon; R⁸ is a C1-C10 alkyl or —OR⁰, where R¹⁰ is a C1-C2 hydrocarbon R⁹ is a divalent C2-C60 hydrocarbon; n is an integer between 0 or 1; and b is 0 or 1;
(c) a silane of the formula (III):

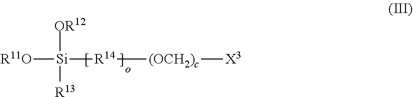

where R¹¹ and R¹² are each independently chosen from a monovalent C3-C20 hydrocarbon; R¹³ is a C1-C10 alkyl or —OR¹⁵, R¹⁵ is a monovalent C1-C2 hydrocarbon; R¹⁴ is a divalent C2-C60 hydrocarbon; o is an integer between 0 to 1; and c is 0 or 1; and
(d) a silane of the formula (IV):

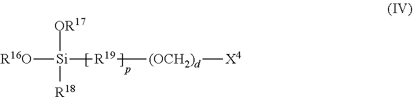

where R¹⁶, R¹⁷, and R¹⁸ are each independently selected from a monovalent C3-C20 hydrocarbon; R¹⁹ is selected from a divalent C2-C60 hydrocarbon; p is an integer between 0 to 1; and d is 0 or 1; and
X¹, X², X³, and X⁴ are each independently selected from an alkyl group, an aromatic group, an alicyclic group, an alkenyl group, an amino group, an acrylic, an acryloxy group, an amidegroup, a mercapto group, a cyano group, a hydroxyl group, or an epoxy group.

In one embodiment, provide is an oligomer synthesized by the process.

In one embodiment, provided is a composition comprising a mixture of one or more oligomers synthesized by the process.

In one embodiment, provided is a composition comprising a mixture of at least one silane selected from the group consisting of (a)-(d) and at least one oligomer synthesised by the process of the previous embodiment.

In one aspect, provided is a process for coating a substrate comprising applying the composition of any of the previous embodiments to at least one surface of the substrate. In one embodiment, provided is a coated substrate prepared by the process.

In one aspect, provided is a process for preparing a film or an article, the process comprising coalescence or contacting the composition in accordance with any of the previous embodiments with a catalyst, moisture, or a radiation.

In one aspect, provided is a process for preparing a film or an article, the process comprising exposing the composition as claimed in accordance with any of the previous embodiments to a curing condition. In one embodiment, the curing condition is a curing pH or a curing temperature. In one embodiment, provided is a cured film or article as prepared by the process.

In one aspect, provided is a cured film or article formed from the composition of any of the previous embodiments.

In one aspect, provided is a process for producing an organic functional silane composition in accordance with any of the previous embodiments, the process comprising:
(a) combining a transesterification catalyst and transesterifiable alkoxysilane to provide a mixture thereof;
(b) subjecting the mixture from step (a) to transesterification reaction conditions upon addition of transesterifying alcohol thereto;
(c) adding transesterifying alcohol to the mixture of step a before and/or during step (b) to provide a transesterification reaction medium thereby commencing transesterification and producing upon such alkoxysilane transesterification reaction product;
(d) optionally deactivating the transesterification catalyst from the transesterification reaction medium to provide a catalyst-depleted transesterification reaction medium containing alkoxysilane transesterification reaction product;
(e) optionally removing byproduct alcohol formed during transesterification from the transesterfication reaction medium; and
(f) optionally separating alkoxysilane transesterification reaction product from the transesterification catalyst-depleted transesterification reaction medium of step (d).

The following description and the drawings disclose various illustrative aspects. Some improvements and novel aspects may be expressly identified, while others may be apparent from the description and drawings.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As used in the specification and including the appended claims, the singular forms “a,” “an,” and “the” include the plural, and reference to a particular numerical value includes at least that particular value, unless the context clearly dictates otherwise.

Ranges expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

It will be understood that any numerical range recited herein includes all sub-ranges within that range and any combination of the various endpoints of such ranges or sub-ranges. Additionally, numerical values for a given component can be combined to form new and non-specified ranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

The expression “hydrocarbon radicals” means any hydrocarbon group from which one or more hydrogen atoms has been removed and is inclusive of alkyl, alkenyl, alkynyl, cyclic alkyl, cyclic alkenyl, cyclic alkynyl, aryl, aralkyl and arenyl and may contain heteroatoms.

The term “alkyl” means any monovalent, saturated straight, branched or cyclic hydrocarbon group. Examples of alkyls include, but are not limited to, methyl, ethyl, propyl, isopropyl, butyl, isobutyl, tert-butyl, pentyl, hexyl, heptyl, octyl, etc.

The term “cyclic alkyl” includes bicyclic, tricyclic and higher cyclic structures as well as the aforementioned cyclic structures further substituted with alkyl, alkenyl, and/or alkynyl groups. Representative examples include norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

Hydrocarbon or alkyl groups of three or more carbon atoms include linear or branched structures of such compounds.

Provided is an organic functional alkoxysilane composition. The functional alkoxysilane composition comprises two or more functional alkoxysilanes in which at least one of the functional alkoxysilanes has one or more alkoxy groups with an alkyl group of 3 or more carbon atoms. A composition with a mixture of different organic functional alkoxysilanes including alkoxysilanes having larger alkyl groups has been found to provide improved wear properties to coating compositions, such as, but not limited to, paint compositions.

The present composition comprises organic functional alkoxysilane monomers, oligomers of organic functional alkoxysilane monomers, or a mixture of organic functional alkoxysilane monomer(s) and an oligomer of organic functional alkoxysilane monomers. In one embodiment, the organic functional alkoxysilane composition comprises (i) an organic functional alkoxy silane comprising an organic functional group and two or more alkoxy groups bound to a silico atom where at least two alkoxy groups are lower carbon alkoxy groups (e.g., methoxy and/or ethoxy); and (ii) an organic functional alkoxy silane comprising an organic functional group bound to a silicon atom and one or more alkoxy groups bound to a silicon atom with at least one alkoxy group having an alkoxy group with higher carbon alkoxy groups (e.g., alkoxy groups of three or more hydrocarbons), or an oligomer of (i) and (ii).

The silane monomers include an organic functional group bound to the silicon atom. The organic functional group can be selected from a reactive or a non-reactive functional group. Examples of suitable organic functional groups include, but are not limited to, an alkyl, an aromatic, an alicyclic group, an alkenyl, amino, acrylic, acryloxy, amide, mercapto, cyano, hydroxyl, thio, acrylamido, an epoxy group and the like.

In one embodiment, the organic functional silane is an epoxy functional silane comprising an epoxy group. The epoxy group is not particularly limited and can be selected from, for example, a glycidyl group or a glycidoxy group. The epoxy functional group is generally bound to the silicon atom in the alkoxysilane via a linker group such as a C1 to C60 alkyl group optionally containing heteroatoms. In one embodiment, the epoxy functional group is a glycidyllalkyl group. In one embodiment, the epoxy functional group is a glycidoxyalkyl functional group. The glycidoxyalkyl functional group includes comprises the group epoxy-(CH₂—O)-alkyl- bound to the silicon atom.

In one embodiment, the epoxy group is:

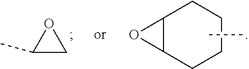

The organic functional silane can be an epoxy alkoxysilane, which can be an epoxy functional trialkoxysilane or an epoxy functional dialkoxysilane.

In one embodiment, the organic functional silane is an alkyl functional silane comprising an alkyl group. The alkyl group can be selected from a C1-C10 alkyl, a C2-C8 alkyl, or a C4-C6 alkyl. The alkyl group may be linear or branched. Example of suitable alkyl groups include, but are not limited to, methyl, ethyl, propyl, isopropyl, butyl, isobutyl, tert-butyl, pentyl, isopentyl, hexyl, heptyl, octyl, nonyl, or decyl.

In one embodiment, the organic functional silane comprises an aromatic group. The aromatic group can be selected from a C6-C30 aromatic group. The aromatic group can be substituted or unsubstituted. The aromatic group can contain one or more aromatic rings. Aromatic groups containing two or more aromatic rings can be such that the rings are joined by a bond, joined by a linking group, or fused. Example of suitable aromatic groups include, but are not limited to phenyl, tosyl, xylyl, and the like.

In one embodiment, the organic functional silane comprises an alicyclic group. The alicyclic group can be selected from a C3-C30 cycloalkyl, a C3-C30 cycloalkenyl, or a C3-C30 cycloalkynyl group.

In one embodiment, the organic functional silane comprises an alkenyl group. The alkenyl group can be selected from a C2-C20 alkenyl comprising one or more unsaturated carbon-carbon bonds. In one embodiment, the alkenyl group is selected from a vinyl (H2C═CH—) or allyl (H2C═CH—CH2-) group.

In one embodiment, the organic functional group is selected from an amino group. The amino group can be selected from —NH2, —N(R)H, or —N(R′)(R″), where R, R′, and R″ are organic groups selected from a C1-C10 alkyl group.

In one embodiment, the organic functional group is selected from an amide group. The amide can be selected from a group of the formula —C(O)—NH₂, —C(O)—NH—R′, and a tertiary amide group may be represented by the structural formula —C(O)—NR′R″, where R′ and R″ are organic groups selected from C1-C10 alkyl group.

In one embodiment, the organic functional group is selected from an acryloxy group. The term acryloxy may include methacryloxy groups. Such groups can be represented by CH₂═CRC(O)—, wherein R is H or CH₃, Similarly, the term “(meth)acryloxy” indicates acryloxy, methacryloxy or any combination thereof; the term “(meth)acrylic acid” indicates acrylic acid, methacrylic acid or any combination thereof; the term “(meth)acrylate” indicates acrylate, methacrylate or any combination thereof, and the term “(meth)acrylamide” indicates acrylamide, methacrylamide or any combination thereof.

In one embodiment, the organic functional alkoxysilane composition comprises silane monomers or an oligomer of one or more silane monomers that are selected from:
(a) a silane of the formula (I):

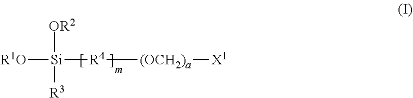

where R¹ and R² are each independently chosen from a monovalent C1-C2 hydrocarbon; R³ is a C1-C10 alkyl or —OR⁵, where R⁵ is a C1-C2 hydrocarbon; R⁴ is a C2-C60 divalent hydrocarbon; X¹ is selected from an alkyl group, an aromatic group, an alicyclic group, an alkenyl group, an amino group, an acrylic, an acryloxy group, an amidegroup, a mercapto group, a cyano group, a hydroxyl group, thio, acrylamido or an epoxy group; m is an integer between 0 or 1; and a is 0 or 1;
(b) a silane of the formula (II):

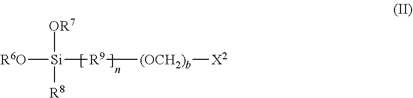

where R⁶ is chosen from a monovalent C1-C2 hydrocarbon; R⁷ is a C3-C20 monovalent hydrocarbon; R⁸ is a C1-C10 alkyl or —OR⁰, where R¹⁰ is a C1-C2 hydrocarbon R⁹ is a divalent C2-C60 hydrocarbon; X² is selected from an alkyl group, an aromatic group, an alicyclic group, an alkenyl group, an amino group, an acrylic, an acryloxy group, an amidegroup, a mercapto group, a cyano group, a hydroxyl group, thio, acrylamido or an epoxy group; n is an integer between 0 or 1; and b is 0 or 1;
(c) a silane of the formula (III):

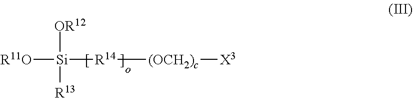

where R¹¹ and R¹² are each independently chosen from a monovalent C3-C20 hydrocarbon; R¹³ is a C1-C10 alkyl or —OR¹⁵, R¹⁵ is a monovalent C1-C2 hydrocarbon; R¹⁴ is a divalent C2-C60 hydrocarbon; X³ is selected from an alkyl group, an aromatic group, an alicyclic group, an alkenyl group, an amino group, an acrylic, an acryloxy group, an amidegroup, a mercapto group, a cyano group, a hydroxyl group, thio, acrylamido or an epoxy group; o is an integer between 0 or 1; and c is 0 or 1;
and
(d) a silane of the formula (IV):

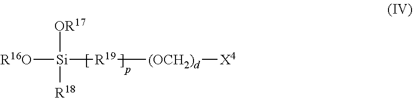

where R¹⁶, R¹⁷, and R¹⁸ are each independently selected from a monovalent C3-C20 hydrocarbon; R¹⁹ is selected from a divalent C2-C60 hydrocarbon; X⁴ is selected from an alkyl group, an aromatic group, an alicyclic group, an alkenyl group, an amino group, an acrylic, an acryloxy group, an amidegroup, a mercapto group, a cyano group, a hydroxyl group, thio, acrylamido or an epoxy group p is an integer between 0 or 1; and d is 0 or 1.

X¹, X², X³, and X⁴ can be the same or different. They can be the exact same group. They can be selected from the same generic category of compound but be different species within that category. In still another embodiment, they independently be groups of different categories.

In one embodiment, X¹, X², X³, and X⁴ are each independently an epoxy functional group. In one embodiment, m, n, o, and p are each 1, and the respective R⁴, R⁹, R¹⁴, and R¹⁹ are each a C3 hydrocarbon; a, b, c, and d are each 1; and the epoxy group is

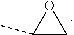

In another embodiment, m, n, o, and p are each 1, and the respective R⁴, R⁹, R¹⁴, and R¹⁹ are each a C2 hydrocarbon; a, b, c, and d are each 0; and the epoxy group is

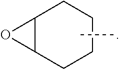

In one embodiment, X¹, X², X³, and X⁴ are independently selected from an alkenyl group, m, n, o, and p are each 0, and a, b, c, and d are each 0. In one embodiment, X¹, X², X³, and X⁴ are each vinyl and a, b, c, d, m, n, o, and p are each 0. In one embodiment, X¹, X², X³, and X⁴ are each amine group and m, n, o, and p are each 1, R⁴, R⁹, R¹⁴, and R¹⁹ are each a C3 hydrocarbon, and a, b, c, and d are each 0. In one embodiment, X¹, X², X³, and X⁴ are each cyano group and m, n, o, and p are each 1, R⁴, R⁹, R¹⁴, and R¹⁹ are each a C3 hydrocarbon, and a, b, c, and d are each 0. In one embodiment, X¹, X², X³, and X⁴ are each thiol group and m, n, o, and p are each 1, R⁴, R⁹, R¹⁴, and R¹⁹ are each a C3 hydrocarbon, and a, b, c, and d are each 0. In one embodiment, X¹, X², X³, and X⁴ are each acryloxy group and m, n, o, and p are each 1, R⁴, R⁹, R¹⁴, and R¹⁹ are each a C3 hydrocarbon, and a, b, c, and d are each 0. In one embodiment, X¹, X², X³, and X⁴ are each acrylamido group and m, n, o, and p are each 1, R⁴, R⁹, R¹⁴, and R¹⁹ are each a C3 hydrocarbon, and a, b, c, and d are each 0.

In one embodiment, in silane (a) a is 0 and R⁴ is a C2-C10 alkyl, C3-C8 alkyl, or C4-C6 alkyl. In one embodiment, a is 1 and R⁴ is a C2-C10 alkyl, a C3-C8 alkyl or a C4-C6 alkyl. In one embodiment, a is 1, and R⁴ is a C3 divalent alkyl selected from propyl or isopropyl. R¹, R², and R³ can be the same or different. In one embodiment, each of R¹, R², and R³ is methyl. In one embodiment, each of R¹, R², and R³ is ethyl.

Silane (b) includes an alkoxy group having three or more carbon atoms. In one embodiment, R⁷ is a C3-C20 hydrocarbon selected from a linear, branched, or cyclic alkyl group. In one embodiment, R⁷ is a C3-C10 hydrocarbon, a C4-C8 hydrocarbon, or a C5-C6 hydrocarbon. In one embodiment, R⁷ is selected from propyl, isopropyl, butyl, isobutyl, tert-butyl, pentyl, iso-pentyl, neopentyl, hexyl, heptyl, or octyl. In embodiments of silane (b), b is 0. In other embodiments, b is 1, and R⁹ is a C3-C10 divalent hydrocarbon and in one embodiment is a C3 divalent hydrocarbon. In embodiments, R⁸ is —OR¹⁰, and R⁶ and R¹⁰ may be the same or different. In one embodiment, R⁶ and R¹⁰ are each methyl. In one embodiment, R⁶ and R¹⁰ are each ethyl.

Silane (c) includes two alkoxy groups having three or more carbon atoms. In one embodiment, R″ and R¹² are each independently selected from a C3-C20 hydrocarbon. The C3-C20 hydrocarbons can selected from a linear, branched, or cyclic alkyl group. R″ and R² can be the same or different from one another. In one embodiment, R″ and R¹² are the same. In one embodiment, R¹ and R¹² are different. In one embodiment, R″ and R¹² are each independently selected from a C3-C10 hydrocarbon, a C4-C8 hydrocarbon, or a C5-C6 hydrocarbon. In one embodiment, R″ and R¹² are each independently selected from propyl, isopropyl, butyl, isobutyl, tert-butyl, pentyl, iso-pentyl, neopentyl, hexyl, heptyl, or octyl. In one embodiment, R¹³ is —OR¹⁵, and R¹⁵ is methyl. In one embodiment, R¹⁵ is ethyl. In embodiments of silane (c), c is 0. In other embodiments, c is 1, and R¹⁴ is a C3-C10 divalent hydrocarbon and in one embodiment is a C3 divalent hydrocarbon.

Silane (d) includes three alkoxy groups having three or more carbon atoms. In one embodiment, R¹³, R¹⁴, and R¹⁵ are each independently selected from a C3-C20 hydrocarbon. The C3-C20 hydrocarbons can selected from a linear, branched, or cyclic alkyl group. R¹³, R¹⁴, and R¹⁵ can be the same or different from one another. In one embodiment, R¹³, R¹⁴, and R¹⁵ are the same. In one embodiment, R¹³, R¹⁴, and R¹⁵ are different. In one embodiment, R¹³, R¹⁴, and R¹⁵ are each independently selected from a C3-C10 hydrocarbon, a C4-C8 hydrocarbon, or a C5-C6 hydrocarbon. In one embodiment, R¹³, R¹⁴, and R¹⁵ are each independently selected from propyl, isopropyl, butyl, isobutyl, tert-butyl, pentyl, iso-pentyl, neopentyl, hexyl, heptyl, or octyl. In embodiments of silane (d), d is 0. In other embodiments, d is 1, and R¹⁶ is a C3-C10 divalent hydrocarbon and in one embodiment is a C3 divalent hydrocarbon.

The silane composition comprises two or more functional alkoxy silanes with at least one functional alkoxy silane having an alkoxy group that includes three or more carbon atoms or an oligomer of such silane functional alkoxysilane monomers. In one embodiment, the silane composition comprises at least one of silane (a) and/or silane (b), and at least one of silane (c) and/or silane (d). While not being bound to any particular theory, having some of silane (a) and/or silane (b) may be beneficial as they are more hydrolyzable, and the silanes (c) and (d) with the higher carbon alkoxy groups have been found to provide improved wear or scrub resistance to coating compositions comprising the silane compositions.

In one embodiment, the silane composition comprises silane (a) and silane (b). Silane (a) can be present in an amount of from about 0.1 mol % to about 99.9 mol %, from about 1 mol % to about 50 mol %, or from about 5 mol % to about 10 mol %, and silane (b) can be present in an amount of from about 0.1 mol % to about 99.9 mol %, from about 5 mol % to about 80 mol %, or from about 10 mol % to about 60 mol % based on the total mols of the silane composition.

In one embodiment, the silane composition comprises silane (a) and silane (c). Silane (a) can be present in an amount of from about 0.1 mol % to about 99.9 mol %, from about 1 mol % to about 50 mol %, or from about 5 mol % to about 10 mol %, and silane (c) can be present in an amount of from about 0.1 mol % to about 99.9 mol %, from about 10 mol % to about 90 mol %, or from about 30 mol % to about 80 mol % based on the total mols of the silane composition.

In one embodiment, the silane composition comprises silane (a) and silane (d). Silane (a) can be present in an amount of from about 0.1 mol % to about 99.9 mol %, from about 1 mol % to about 50 mol %, or from about 5 mol % to about 10 mol %, and silane (d) can be present in an amount of from about 0.1 mol % to about 99.9 mol %, from about 1 mol % to about 80 mol %, or from about 10 mol % to about 60 mol % based on the total mols of the silane composition.

In one embodiment, the silane composition comprises silane (b) and silane (c). Silane (b) can be present in an amount of from about 0.1 mol % to about 99.9 mol %, from about 5 mol % to about 80 mol %, or from about 10 mol % to about 60 mol %, and silane (c) can be present in an amount of from about 0.1 mol % to about 99.9 mol %, from about 10 mol % to about 90 mol %, or from about 30 mol % to about 80 mol % based on the total mols of the silane composition.

In one embodiment, the silane composition comprises silane (b) and silane (d). Silane (b) can be present in an amount of from about 0.1 mol % to about 99.9 mol %, from about 5 mol % to about 80 mol %, or from about 10 mol % to about 60 mol %, and silane (d) can be present in an amount of from about 0.1 mol % to about 99.9 mol %, from about 1 mol % to about 80 mol %, or from about 10 mol % to about 60 mol % based on the total weight of the silane composition.

In one embodiment, the silane composition comprises silane (a), silane (b), and silane (c). Silane (a) can be present in an amount of from about 0.1 mol % to about 99.8 mol %, from about 1 mol % to about 50 mol %, or from about 3 mol % to about 10 mol %, silane (b) can be present in an amount of from about 0.1 mol % to about 99.8 mol %, from about 5 mol % to about 80 mol %, or from about 10 mol % to about 60 mol %, and silane (c) can be present in an amount of from about 0.1 mol % to about 99.8 mol %, from about 10 mol % to about 90 mol %, or from about 30 mol % to about 80 mol % based on the total mols of the silane composition.

In one embodiment, the silane composition comprises silane (a), silane (b), and silane (d). Silane (a) can be present in an amount of from about 0.1 mol % to about 99.8 mol %, from about 1 mol % to about 50 mol %, or from about 3 mol % to about 10 mol %, silane (b) can be present in an amount of from about 0.1 mol % to about 99.8 mol %, from about 5 mol % to about 80 mol %, or from about 10 mol % to about 60 mol %, and silane (d) can be present in an amount of from about 0.1 mol % to about 99.8 mol %, from about 1 mol % to about 80 mol %, or from about 10 mol % to about 60 mol % based on the total mol of the silane composition.

In one embodiment, the silane composition comprises silane (a), silane (c), and silane (d). Silane (a) can be present in an amount of from about 0.1 mol % to about 99.8 mol %, from about 1 mol % to about 50 mol %, or from about 3 mol % to about 10 mol %, silane (c) can be present in an amount of from about 0.1 mol % to about 99.8 mol %, from about 10 mol % to about 90 mol %, or from about 30 mol % to about 80 mol %, and silane (d) can be present in an amount of from about 0.1 mol % to about 99.8 mol %, from about 1 mol % to about 80 mol %, or from about 10 mol % to about 60 mol % based on the total mol of the silane composition.

In one embodiment, the silane composition comprises silane (b), silane (c), and silane (d). Silane (b) can be present in an amount of from about 0.1 mol % to about 99.8 mol %, from about 5 mol % to about 80 mol %, or from about 10 mol % to about 60 mol %, silane (c) can be present in an amount of from about 0.1 mol % to about 99.8 mol %, from about 10 mol % to about 90 mol %, or from about 30 mol % to about 80 mol %, and silane (d) can be present in an amount of from about 0.1 mol % to about 99.8 mol %, from about 1 mol % to about 80 mol %, or from about 10 mol % to about 60 mol % based on the total mols of the silane composition.

In one embodiment, the silane composition comprises silane (a), silane (b), silane (c), and silane (d). Silane (a) can be present in an amount of from about 0.1 mol % to about 99.7 mol %, from about 0.5 mol % to about 50 mol %, or from about 1 mol % to about 10 mol %; silane (b) can be present in an amount of from about 0.1 mol % to about 99.7 mol %, from about 5 mol % to about 80 mol %, or from about 10 mol % to about 60 mol %, silane; (c) can be present in an amount of from about 0.1 mol % to about 99.7 mol %, from about 10 mol % to about 90 mol %, or from about 30 mol % to about 80 mol %; and silane (d) can be present in an amount of from about 0.1 mol % to about 99.7 mol %, from about 1 mol % to about 80 mol %, or from about 10 mol % to about 60 mol % based on the total mols of the silane composition.

It will be appreciated by those skilled in the art that the amounts of the respective functional alkoxy silane monomers in the compositions will add up to 100 mol %. Thus, even though the various end points of the ranges described for the respective components in the composition may add up to less than or more than 100%, the total amount of the monomers (when present as monomers) will be 100%.

In one embodiment, the composition may comprise an oligomer formed from one or more of monomers (a), (b), (c), and (d). That is, the oligomers can be homo- or co-oligomers. In one embodiment, the composition consists essentially of oligomers formed from two or more of monomers (a), (b), (c), and (d). In one embodiment, the composition comprises a mixture of (i) one or more individual monomers (a), (b), (c), and (d); and (ii) one or more oligomers formed from one or more of the monomers (a), (b), (c), and/or (d).

The silane composition comprising a mixture of silane monomers may be prepared by transesterification reaction comprising: (a) combining a transesterification catalyst and transesterifiable alkoxysilane to provide a mixture thereof; (b) subjecting the mixture from step (a) to transesterification reaction conditions upon addition of transesterifying alcohol thereto; (c) adding transesterifying alcohol to the mixture of step a before and/or during step (b) to provide a transesterification reaction medium thereby commencing transesterification and producing upon such alkoxysilane transesterification reaction product; (d) deactivating the transesterification catalyst from the transesterification reaction medium to provide a catalyst-depleted transesterification reaction medium containing alkoxysilane transesterification reaction product; and, optionally, (e) removing byproduct alcohol formed during transesterification from the transesterfication reaction medium; (f) separating alkoxysilane transesterification reaction product from the transesterification catalyst-depleted transesterification reaction medium of step (d).

The transesterifiable alkoxysilane in embodiments is selected from an organic functional silane having the lower carbon alkoxy groups. Thus, in embodiments, the transesterifiable alkoxysilane is an organic functional trimethoxy silane, organic functional triethoxy silane, organic functional dimethoxyethoxy silane, or organic functional diethyoxymethoxy silane. In one embodiment, the transesterifiable alkoxysilane is selected from in embodiments is selected from an epoxy functional silane having the lower carbon alkoxy groups. Thus, in embodiments, the transesterifiable alkoxysilane is an epoxy functional trimethoxy silane, epoxy functional triethoxy silane, epoxy functional dimethoxyethoxy silane, or epoxy functional diethyoxymethoxy silane

The transesterifying alcohol, in embodiments, is selected from a higher hydrocarbon alcohol, e.g., an alcohol comprising three or more carbon atoms. The transesterifying alcohol can be selected as desired to provide desired higher carbon alkoxy groups. Examples of suitable transesterifying alcohols include, but are not limited to, propanol, isopropyl alcohol, butyl alcohol, isobutyl alcohol, tert-butyl alcohol, etc.

Examples of suitable transesterification catalysts include, but are not limited to, titanium isopropoxide diazabicyclo(5.4.0)undec-7-ene (DBU).

As described above, the preparation of the trans-esterified silanes can be achieved from the combination of many different useful parameters such as (a) metal/non metallic catalyst, (b) alcohol type-branched/linear etc., (c) process type: batch, semi-batch or continuous addition of IPA, (d) with/without catalyst deactivation, (e) with/without removing alcohol byproduct(s), (f) with/without product purification, and (g) optional choice of removing the starting materials etc.

Oligomers of the organic functional alkoxysilanes can be prepared by heating a mixture of the organic functional alkoxysilane monomers in the present of a catalyst.

In one embodiment, the organic functional alkoxysilane composition can be reacted with one or more monomers or functional polymers such that the silanes in the composition form copolymers. The monomers can be selected as desired for a particular purpose or intended application. Examples of suitable monomers include, but are not limited to, ethyleneically unsaturated monomers, acrylate monomers, and the like. Some suitable acrylate monomers include, but are not limited to, acrylonitrile, acrylic acid, methyl acrylate, ethyl acrylate, butyl acrylate, 24 ethylhexyl acrylate, methoxyethyl acrylate, diaminoethyl acrylate, methacrylic acid, methyl methacrylate, ethyl methacrylate, isobutyl methacrylate, 2-ethylhexyl methacryclate, lauryl methacrylate, stearic methacryclate, dimethylaminoethyl methacrylate, 2-hydroxylpropyl acrylate, 2-hydroxylpropyl metacrylate, acrylamide, methacrylamide, glycidyl acrylate and the like. Examples of ethyleneically unsaturated monomers include, but are not limited to, styrene, divinyl benzene, N-vinyl pyrrolidone, N-vinyl lactam, vinyl halides, vinyl acetates, vinyl alcohols, allyl alcohols, allyl polyethers, and thiol.

The silane composition is useful in a variety of applications alone or as an additive in a composition. The silane composition can be employed as a coating, a sealant, an adhesive, etc. The silane composition itself can be employed as a coating, a sealant, an adhesive, etc., or the silane composition can be a component of a coating, sealant, or adhesive composition. In one embodiment, the silane composition is itself provided as a coating composition and used to form a coating on a substrate or used for surface treatment. In one embodiment, the silane composition is emulsified with appropriate surfactant and shear to disperse/emulsified in water prior to use by itself or as a component of a coating, sealant, or adhesive composition.

In one embodiment, Silane composition reaction to organic monomers can be carried out using emulsion polymerisation methods such as a batch process or a semi-continuous or a continuous process like seed process or feed process. The polymerization utilizes one initiator which could be a peroxide initiator or redox initiator or macro initiator. It is possible to use at least one emulsifier which may be anionic, cationic or non-ionic. There could be reactive or polymerisable initiators present. Further additives that are customary to add in the emulsion polymerisation could be added.

A coating, sealant, or adhesive composition can formed by any suitable method depending on the base composition. Formation of the coating, sealant, or adhesive can be by temperature (e.g., heating to facilitate reaction and drive off solvent), moisture curing, catalytic curing, UV irradiation, etc. Those skilled in the art will be able to determine the appropriate mode of curing depending on the base composition.

A coating, sealant, or adhesive can include any other suitable additive as may be desired for a particular purpose or intended application. Examples of suitable additives include, but are not limited to, binders, pigments, fillers, curing catalysts, dyes, plasticizers, thickeners, coupling agents, extenders, dispersants, surfactants, glycols, coalescents, other silanes, silicones, cross-linkers, curing agent, adhesion promoters, tackifiers, antioxidants, UV stabilizers, etc. Suitable fillers include, but are not limited to, inorganic compounds such as, for example, chalk, lime flour, precipitated and/or pyrogenic silica, aluminum silicates, ground minerals and other inorganic fillers familiar to one skilled in the art. In addition, organic fillers, particularly short-staple fibers and the like, may also be used. Fillers that impart desirable thixotropic properties, e.g., swellable polymers, may be utilized for certain applications.

In one embodiment, the silane composition is useful as an additive in a coating composition. In one embodiment, provided is a coating composition comprising (i) a base coating composition, and (ii) the silane composition comprising a mixture of organic functional functional alkoxysilanes. The silane composition comprising the mixture of organic functional functional alkoxysilanes can be present in the coating composition in an amount of from about 0.001 wt. % to about 10 wt. %, from about 0.1 wt. % to about 7.5 wt. %, from about 0.5 wt. % to about 5 wt. %, or from about 1 wt. % to about 2.5 wt. % based on the total weight of the coating composition. In one embodiment, the present silane composition is present in an amount of from about 0.1 wt. % to about 1 wt. %. The base coating composition comprises the remaining materials suitable for forming a coating and can be provided in an amount of from about 90 wt. % to about 99.95 wt. %, from about 92.5 wt. % to about 99.9 wt. %, from about 95 wt. % to about 99.5 wt %, or from about 97.5 wt. % to about 99 wt. %

The base coating composition is generally not limited and can be selected as desired for a particular purpose or intended application. The base coating can be waterborne or solvent borne composition.

In one embodiment, the coating composition can further a conventional latex paint formulation. Generally, conventional latex paints include two phases, an external phase and an internal phase. The external phase is water in which additives, such as wetting agents (surfactants or emulsifiers), dispersants, cellulosic thickeners to control paint rheology and package stability, glycols to control application characteristics and temperature sensitivity, and bactericides to protect the paint from bacterial attack and putrefaction, are added. The internal phase of conventional latex paints contains pigment dispersed to finite particle size and latex particles.

The emulsifiers employed in the composition are not particularly limited and can be selected as desired for a particular purpose or intended use. The emulsifier can be a single type of emulsifier or may be provided as an emulsifier system. Examples of emulsifiers for aqueous systems are described in U.S. Pat. No. 10,259,748, which is incorporated herein by reference in its entirety. Suitable emulsifiers for the composition (alone or as part of an emulsifier system) can be selected from, but are not limited to, alkyl sulfates having C8-C18 alkyl, alkyl ether sulfates and alkaryl ether sulfates having C8-C18 alkyl in the hydrophobic radical and having 1 to 40 ethylene oxide (EO) and/or propylene oxide (PO) units, alkylsulphonates having C8-C18-alkyl, sodium laurylsulphate (C12-C16), alkarylsulphonates having C8-C18 alkyl, monoesters of sulphosuccinic acid with monohydric alcohols or alkylphenols having 5 to 15 carbon atoms, alkali metal and ammonium salts of carboxylic acids having 8 to 20 carbon atoms in the alkyl, aryl, alkaryl or aralkyl radical, alkyl and alkaryl phosphates having 8 to 20 carbon atoms in the organic radical, alkyl ether or alkaryl ether phosphates having 8 to 20 carbon atoms in the alkyl or alkaryl radical and 1 to 40 EO units, alkyl polyglycol ethers and alkaryl polyglycol ethers having 8 to 40 EO units and C8-C20 carbon atoms in the alkyl or aryl radicals, ethylene oxide/propylene oxide (EO/PO) block copolymer having 8 to 40 EO and/or PO units, addition products of alkylamines having C5-C22 alkyl radicals with ethylene oxide or propylene oxide, alkyl polyglycosides having linear or branched, saturated or unsaturated C8-C24-alkyl radicals and oligoglycosides radicals having 1 to 10 hexose or pentose units, silicon-functional surfactants or mixtures of these emulsifiers.

The coating composition can comprise one or more fillers. The filler can be selected as desired for a particular purpose or intended application. Examples of suitable fillers include, but are not limited to, aluminosilicates, such as feldspars; silicates such as kaolin; talc; mica; magnesite; Alkaline earth carbonates, such as calcium carbonate, for example in the form of calcite or chalk, magnesium carbonate; dolomite; alkaline earth sulphate, such as calcium sulfate; silica, etc.

The coating composition can comprise one or more pigments. The pigment can be chosen for a particular purpose or intended application. Examples of suitable pigments include but are not limited to, for example, titanium dioxide, barium sulfate, zinc oxide, zinc sulfide, basic lead carbonate, antimony trioxide, lithopone (zinc sulfide+barium sulfate), iron oxides, carbon black, graphite, luminous pigments, zinc yellow, zinc green, ultramarine, manganese black, Antimony Black, Manganese Violet, Paris Blue or Schweinfurt Green. List of organic pigments that may be include but not limited to are B. Sepia, Cambogia, Kasseler Braun, Toluidine Red, Pararot, Hansa yellow, indigo, azo dyes, anthraquinoid and indigoid color and dioxazine, quinacridone, phthalocyanine, isoindoli- contain non- and metal complex pigments.

In another embodiment, the composition of the present invention can further comprise one or more conventional organsilane compounds other than the silane monomers of the present organic functional silane compositions. These can include, for example, silane oligomers. In embodiments, the additional silanes can be selected from a monomeric silane such as a vinyl silane, an alkyl silane or an alkylene silane. Examples of non-epoxy based monomeric silanes include, but are not limited to, vinyltrimethoxysilane (e.g., Silquest® A-171 available from Momentive Performance Materials Inc.), vinyltriethoxysilane (e.g., Silquest® A-151 available from Momentive Performance Materials Inc.), vinylmethyldimethoxysilane (e.g., Silquest® A-2171 available from Momentive Performance Materials Inc.), vinyltriisopropoxysilane (e.g., CoatOSil® 1706 available from Momentive Performance Materials Inc.), n-octyltriethoxy silane (e.g., Silquest® A-137 available from Momentive Performance Materials Inc.), propyltriethoxy silane (e.g., Silquest® A-138 available from Momentive Performance Materials Inc.), propyltrimethoxysilane, methyltrimethoxysilane (e.g., Silquest®) A-1630 available from Momentive Performance Materials Inc.), methyltriethoxysilane (e.g., Silquest® A-162 available from Momentive Performance Materials Inc.), polyalkyleneoxidetrimethoxysilane (e.g., Silquest® A-1230 available from Momentive Performance Materials Inc.), 3-methacryloxypropyltrimethoxy silane (e.g., Silquest® A-174 available from Momentive Performance Materials Inc.), 3-methacryloxypropyltriethoxy silane (e.g., Silquest® Y-9936 available from Momentive Performance Materials Inc.) or 3-methacryloxypropyltriisopropoxy silane (e.g., CoatOSil® 1757 available from Momentive Performance Materials Inc.Silicones).

According to another embodiment, the organic functional alkoxysilane compositions of the present invention can be used in water borne zinc rich primers or protective coating systems, metallic pigment paste dispersions, a blend of metallic paste dispersion with waterborne, latexes or dispersions for primers, coatings or inks, waterborne protective coatings, waterborne shop primers, metallic pigment dispersions and their use in printing ink or coatings, cross linkers of waterborne latexes and dispersions including but not limited to anionic and cationic dispersions, acrylic styrene acrylic, polyurethane and epoxy dispersions, vinyl resins, adhesion promoters for same systems described above, additive or binder systems for dispersion of metallic fillers and pigments, pigment dispersion for inorganic fillers such as calcium carbonate, kaolin, clay, etc., waterborne protective coatings using zinc and other metallic pigments as sacrificial pigment, waterborne decorative paints for metal, plastics and other substrates.

According to another embodiment, the present organic functional alkoxysilane compositions are used in water borne zinc rich primers or protective coating systems, metallic pigment paste dispersions, a blend of metallic paste dispersion with waterborne latexes or dispersions for primers, coatings or inks, waterborne protective coatings, waterborne shop primers, metallic pigment dispersions and their use in printing ink or coatings, cross linkers of waterborne latexes and dispersions including but not limited to anionic and cationic dispersions, acrylic styrene acrylic, polyurethane and epoxy dispersions, vinyl resins, adhesion promoters for same systems described above, additive or binder systems for dispersion of metallic fillers and pigments, pigment dispersion for inorganic fillers such as calcium carbonate, kaolin, clay, etc., waterborne protective coatings using zinc and other metallic pigments as sacrificial pigment, waterborne decorative paints for metal, plastics and other substrates.

The aqueous medium of the waterborne coating may include a pH agent. The pH-adjusting agent may be, but is not limited to, ammonium hydroxide, sodium hydroxide, potassium hydroxide, 2-amino-2-methyl-1-propanol, boric acid, orthophosphoric acid, acetic acid, glycolic, malic acid, citric acid or other carboxylic acids. In addition, according to an embodiment of the present invention, the pH-adjusting agent is present in an amount ranging of from about 0.5 to about 4.0 weight percent of the aqueous medium.

The aqueous medium of the waterborne coating may include a co-solvent. The co-solvent may be dipropylene glycol methyl ether. Other solvents may include one or combinations of glycol ether solvents or the like. According to another embodiment, the co-solvent is ethylene glycol monomethyl ether (EGME), ethylene glycol monoethyl ether (EGEE), ethylene glycol monopropyl ether (EGPE), ethylene glycol monobutyl ether (EGBE), ethylene glycol monomethyl ether acetate (EGMEA), ethylene glycol monohexyl ether (EGHE), ethylene glycol mono-2-ethylhexyl ether (EGEEHE), ethylene glycol monophenyl ether (EGPhE), diethylene glycol monomethyl ether (diEGME), diethylene glycol monoethyl ether (diEGEE), diethylene glycol monopropyl ether (diEGPE), diethylene glycol monobutyl ether (diEGBE), butyl carbitol, dipropylene glycol dimethyl ether (diEGME), butyl glycol, butyldiglycol or ester-based solvents. According to another embodiment, the ester-based solvents include ethylene glycol monobutyl ether acetate (EGEEA), diethylene glycol monoethyl ether acetate (diEGEEA), diethylene glycol monobutyl ether acetate (diEGBEA), n-propyl acetate, n-butyl acetate, isobutyl acetate, methoxypropylacetate, butyl cellosolve actetate, butylcarbitol acetate, propylene glycol n-butyl ether acetate, t-Butyl acetate or an alcohol-based solvent. According to yet another embodiment, the alcohol-based solvent may be n-butanol, n-propanol, isopropanol or ethanol.

According to another embodiment of the present invention, the co-solvent is present in an amount ranging of from about 0.1 to about 60 weight percent of the aqueous medium.

The aqueous medium of the waterborne coating may include a surfactant. The surfactant may be an alkyl-phenol-ethoxylate surfactant, a cationic surfactant, anionic surfactant, a non-ionic surfactant, or a polyether siloxane based surfactant or any combination thereof. According to an embodiment of the present invention, the surfactant has a hydrophilic-lipophilic balance (HLB) ranging from about 5 to about 13. According to another embodiment of the present invention, the aqueous medium includes two or more surfactants, wherein each of the surfactants independently has an HLB value ranging from about 5 to about 15. In addition, the surfactant may be present in an amount ranging of from about 3 to about 6 weight percent of the aqueous medium. According to yet another embodiment of the present invention, the aqueous medium of the waterborne coating includes a surfactant and a pH-adjusting agent.

The particulate metal of the coating composition may, in general, be any metallic pigment such as finely divided aluminum, manganese, cadmium, nickel, stainless steel, tin, magnesium, zinc, alloys thereof, or ferroalloys. In one embodiment, the particulate metal is zinc dust or zinc flake or aluminum dust or aluminum flake in a powder or paste dispersion form. The particulate metal may be a mixture of any of the foregoing, as well as comprise alloys and intermetallic mixtures thereof. Flake may be blended with pulverulent metal powder, but typically with only minor amounts of powder. The metallic powders typically have particle size such that all particles pass 100 mesh and a major amount pass 325 mesh (“mesh” as used herein is U.S. Standard Sieve Series). The powders are generally spherical as opposed to the leafing characteristic of the flake.

In one embodiment, the metal particulate is a combination of aluminum and zinc. Where the metal particulate is the combination of zinc with aluminum, the aluminum may be present in very minor amount, e.g., from as little as about 2 to about 5 weight percent, of the particulate metal, and still provide a coating of bright appearance. Usually the aluminum will contribute at least about 10 weight percent of the particulate metal. Thus, frequently, the weight ratio of aluminum to zinc in such a combination is at least about 1:9. On the other hand, for economy, the aluminum will advantageously not contribute more than about 50 weight percent of the zinc and aluminum total, so that the aluminum to zinc weight ratio can reach 1:1. The particulate metal content of the coating composition will not exceed more than about 35 weight percent of the total composition weight to maintain best coating appearance, but will usually contribute at least about 10 weight percent to consistently achieve a desirable bright coating appearance. Advantageously, where aluminum is present, and especially where it is present without other particulate metal, the aluminum will provide from about 1.5 to about 35 weight percent of the total composition weight. Typically, when particulate zinc is present in the composition, it will provide from about 10 to about 35 weight percent of the total composition weight. The metal may contribute a minor amount of liquid, e.g., dipropylene glycol or mineral spirits. Particulate metals contributing liquid are usually utilized as pastes, and these pastes can be used directly with other composition ingredients. However, it is to be understood that the particulate metals may also be employed in dry form in the coating composition.

According to another embodiment, the metal particulate can be a corrosion protection filler or pigment such as chromate containing anti corrosive pigments (e.g., zinc chromates and zinc potassium chromates), phosphate containing pigments (e.g., zinc phosphates, alumino triphosphates, calcium magnesium phosphates, barium phosphates, aluminum zinc phosphates, molybdates, wolframates, zirconates and vanadates), metal organic inhibitors like zinc salts of 5-nitrophtalic acid or conductive pigments like iron phosphide.

For the purpose of aiding the dispersion of the particulate metal, a dispersing agent may be added, i.e., surfactant, serving as a “wetting agent” or “wetter,” as such terms are used herein. Suitable wetting agents or mixture of wetting agents include nonionic agents such as the nonionic alkylphenol polyethoxy adducts, for example. Also, anionic wetting agents can be employed, and these are most advantageously controlled foam anionic wetting agents. These wetting agents or mixture of wetting agents can include anionic agents such as organic phosphate esters, as well as the diester sulfosuccinates as represented by sodium bistridecyl sulfosuccinate. The amount of such wetting agent is typically present in an amount from about 0.01 to about 3 weight percent of the total coating composition.

It is contemplated that the composition may contain a pH modifier, which is able to adjust the pH of the final composition. Usually, the composition, without pH modifier, will be at a pH within the range of from about 6 to about 7.5. It will be understood that as the coating composition is produced, particularly at one or more stages where the composition has some, but less than all, of the ingredients, the pH at a particular stage may be below 6. However, when the complete coating composition is produced, and especially after it is aged, which aging will be discussed herein below, then the composition will achieve the requisite pH. Where a modifier is used, the pH modifier is generally selected from the oxides and hydroxides of alkali metals, with lithium and sodium as the preferred alkali metals for enhanced coating integrity; or, it is selected from the oxides and hydroxides usually of the metals belonging to the Groups IIA and IIB in the Periodic Table, which compounds are soluble in aqueous solution, such as compounds of strontium, calcium, barium, magnesium, zinc and cadmium. The pH modifier may also be another compound, e.g., a carbonate or nitrate, of the foregoing metals.

According to another embodiment, the coating composition may contain what is usually referred to herein as a “boric acid component,” or “boron-containing compound.” For the “component” or for the “compound,” as the terms are used herein, it is convenient to use orthoboric acid, commercially available as “boric acid,” although it is also possible to use various products obtained by heating and dehydrating orthoboric acid, such as metaboric acid, tetraboric acid and boron oxide.

The coating composition may optionally contain thickener. The thickener, when present, can contribute an amount of between about 0.01 to about 2.0 weight percent of the total composition weight. This thickener can be a water soluble cellulose ether, including the “Cellosize” (trademark) thickeners. Suitable thickeners include the ethers of hydroxyethylcellulose, methylcellulose, methylhydroxypropylcellulose, ethylhydroxyethylcellulose, methylethylcellulose or mixtures of these substances. Although the cellulose ether needs to be water soluble to augment thickening of the coating composition, it need not be soluble in the organic liquid. When thickener is present, less than about 0.02 weight percent of the thickener will be insufficient for imparting advantageous composition thickness, while greater than about 2 weight percent of thickener in the composition can lead to elevated viscosities which provide compositions that are difficult to work with. According to an embodiment of the present invention, for thickening without deleterious elevated viscosity, the total composition will contain from about 0.1 to about 1.2 weight percent of thickener. It will be understood that although the use of a cellulosic thickener is contemplated, and thus the thickener may be referred to herein as cellulosic thickener, some to all of the thickener may be another thickener ingredient. Such other thickening agents include xanthan gum, associative thickeners, such as the urethane associative thickeners and urethane-free nonionic associative thickeners, which are typically opaque, high-boiling liquids, e.g., boiling above 1000° C. Other suitable thickeners include modified clays such as highly beneficiated hectorite clay and organically modified and activated smectite clay. When thickener is used, it is usually the last ingredient added to the formulation.

The coating composition may contain further additional ingredients in addition to those already enumerated hereinabove. These other ingredients may include phosphates. It is to be understood that phosphorous-containing substituents, even in slightly soluble or insoluble form, may be present, e.g., as a pigment such as ferrophos. The additional ingredients will frequently be substances that can include inorganic salts, often employed in the metal coating art for imparting some corrosion-resistance or enhancement in corrosion-resistance. Materials include calcium nitrate, dibasic ammonium phosphate, calcium sulfonate, 1-nitropropane lithium carbonate (also useful as a pH modifier), or the like, and, if used, these are most usually employed in the coating composition in a total combined amount of from about 0.1 to about 2 weight percent. Greater than about 2 weight percent of such additional ingredient may be utilized where it is present for a combination of uses, such as lithium carbonate used as a corrosion-inhibitor and also as a pH adjusting agent. Most usually the coating composition is free from these further additional ingredients.

In another embodiment of the present invention, the formulation may include, when necessary, a surface active agent for reducing foam or aiding in de-aeration. The de-foamer and de-aerator agent may include mineral oil based material, silicone-based material, a polyether siloxane or any combination thereof. The concentration of the surface active agents can be adjusted to in the range from about 0.01% to about 5% of active material. The surface active agents may be used as a pure material or as a dispersion in water or any other appropriate solvent to disperse them into the final waterborne composition.

The coating composition may also contain surface effect agents for modifying a surface of the coating composition such as increased mar resistance, reduced coefficient of friction, flatting effects, improved abrasion resistance. Examples may include silicone polyether copolymers such as e.g., Silwet® L-7608 and other variants available from GE Silicones.

Typical crosslinkers can also be utilized in the coating composition of the present invention. For example, the crosslinker can be isocyanates, epoxy curing agents, amino agents, aminoamido agents, epoxy amino adducts, carbodiimides, melamines anhydrides, polycarboxylic anhydrides, carboxylic acid resins, aziridines, titanates, organofunctional titanates, organofunctional silanes, etc.

The coating formulation may also contain corrosion inhibitors. Examples of inhibitors may include chromate, nitrite and nitrate, phosphate, tungstate and molybdate, or organic inhibitors include sodium benzoate or ethanolamine.

Alternatively, a waterborne composition is provided which comprises a dispersion of a particulate metal in an aqueous solution including at least one epoxy silane oligomer as described herein above with one or more optional ingredients selected from the group consisting of a surfactant, pH adjusting agent, co-solvent, monomeric silane, binder, and any other ingredients typically employed in coatings, e.g., thickeners, crosslinkers, etc.

The binder can be an inorganic and organic binders. The inorganic binder can be a silicate, ethyl silicate, silica nano particles solution or silicone resin.

The organic binder can be vinylic resins, polyvinyl chlorides, vinyl chloride copolymers, vinylacetate copolymers, vinylacetates copolymers, acrylics copolymers, styrene butadiene copolymers, acrylate, acrylate copolymer, polyacrylate, styrene acrylate copolymers, phenolic resins, melamine resins, epoxy resins, polyurethane resins, alkyd resins, polyvinyl butyral resins, polyamides, polyamidoamines resins, polyvinyl ethers, polybutadienes, polyester resins, organosilicone resin, organopolysiloxane resin and any combinations thereof. Natural binders such as cellulosic derivatives like nitrocellulosic resins, carboxymethyl cellulose, cellulose esters of organic acids, cellulose ethers like hydroxymethyl or ethyl cellulose, modified natural rubbers, natural gums or solution forms of said polymers and copolymers.

The organic binders can also be a non-ionic stabilized resin, an anionic stabilized emulsion, or a cationic stabilized emulsion.

The coating compositions can be employed to form a film or cured article. The coating compositions can be applied to a desired substrate by conventional techniques including, but not limited to spraying, brushing, dipping, spin-coating, etc. Illustrative of substrates include plastic, metal, wood, concrete, and vitreous surfaces. The composition can be exposed to a curing condition suitable to cure the composition to form the film or cured article. This can include exposing the composition to a temperature sufficient to evaporate the water or solvent. The curing temperature may vary depending on whether the composition is water-based or solvent-based and which solvent is employed. Such conditions are ascertainable by those skilled in the art based on the solvent. In one embodiment, the curing temperature can be from about −30° C. to about 400° C., from about 0° C. to about 200° C., or from about 5° C. to about 50° C. In one embodiment, the curing condition may be exposing the composition to a pH sufficient to effect curing. The pH will depend on the particular solvent being used and will be ascertainable by those skilled in the art. In other embodiments, curing can be achieved by exposure to moisture, UV, mixing two or more parts.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

### EXAMPLES

The following describes example embodiments in accordance with aspects and embodiments. The examples are intended to show some example embodiments and are not necessarily intended to limit the scope of the invention to those specific embodiments.

All air- and moisture-sensitive manipulations were carried out using a standard vacuum line, and a round bottom flask under an inert atmosphere of purified nitrogen. The starting silane for the reactions was (3-glycidyloxypropyl)trimethoxysilane (Silquest A-187 available from Momentive Performance Materials Inc.). Isopropanol and isobutanol, titanium isopropoxide with 99.99% purity, and 1,8-diazabicyclo(5.4.0)undec-7-ene were purchased from Sigma Aldrich and used as received for conducting the transesterification reactions of Examples 1-6. Chloroform-d was purchased from Cambridge Isotope Laboratories and was used as received for all NMR characterization purpose.

Scrub Resistance Test: The scrub resistance property of the present silane composition was evaluated according to a Standard Test Methods for Scrub Resistance of Wall Paints (ASTM D2486). Paint formulations were equilibrated for 1 to 2 days and then coated on leneta scrub panel with approximately 150 micron wet film thickness. The coated samples were kept for drying at room temperature for 2 hours, at 60° C. for 17 hours. Then each panel along with dried films were subjected to multiple scrubbing cycles using BYK scrub tester until either of the paint lost its film. The scanned image of the panel obtained after the scrub test were processed with ImageJ software to quantify the percent paint lost for each silane composition compared to the benchmark paint.

Storage Stability Test: A standard paint formula containing the respective silane compositions along with a benchmark paint was subjected to undergo accelerated heat aging at 60° C. for 2 weeks. Scrub resistance properties of each paint was evaluated (ASTM D2486) before and after ageing.

### Synthetic Example 1

(3-Glycidyloxypropyl)trimethoxysilane (23.63 g, 100.0 mmol) and Isopropyl alcohol (48.0 g, 800 mmol) were introduced into a 250 ml, N₂-flushed, 3-neck round bottom flask fitted with a heating mantle, magnetic stirrer, reflux condenser and thermocouple. A rubber septum was used to seal the third neck of the flask. Titanium isopropoxide (0.20 gm, 2800 ppm) was injected into the reactor through the septum. The stirred contents were heated to 70° C. and continued to reflux for 30 hours. The reaction mixture was stripped in vacuo at 85° C. to remove the unreacted isopropanol and methanol by-product. The remaining mixture was then vacuum distilled at 120° C. and 1 mbar pressure when the product (12.0 g) was obtained as clear liquid. The ²⁹Si NMR has confirmed that the product was a mixture of:
3.1 mol percent of (3-glycidyloxypropyl) trimethoxysilane
28.7 mol percent of (3 glycidyloxypropyl)dimethoxyisopropoxysilane
64.9 mol percent of (3-glycidyloxypropyl)methoxydiisopropoxysilane
3.3 mol percent of (3-glycidyloxypropyl)triisopropoxysilane.

### Synthetic Example 2

(3-Glycidyloxypropyl)trimethoxysilane (23.63 g, 100.0 mmol) and isopropyl alcohol (48.0 g, 800 mmol) were introduced into a 250 ml, N₂-flushed, 3-neck round bottom flask fitted with a heating mantle, magnetic stirrer, reflux condenser and thermocouple. A rubber septum was used to seal the third neck of the flask. Titanium isopropoxide (0.20 gm, 2800 ppm) was injected into the reactor through the septum. The stirred contents were heated to 70° C. and continued to reflux for 29 hours. The reaction mixture was stripped in vacuo at 120° C. to remove the unreacted (3-glycidyloxypropyl)trimethoxysilane, isopropanol and methanol by-product. The remaining mixture was then vacuum distilled at 165° C. and 1 mbar pressure when the product (5.0 g) was obtained as clear liquid. The ²⁹Si NMR has confirmed that the product was a mixture of 23.8 mol percent of:
(3-glycidyloxypropyl)dimethoxyisopropoxysilane
70 mol percent of (3-glycidyloxypropyl)methoxydiisopropoxysilane
6.2 mol percent of (3-glycidyloxypropyl)triisopropoxysilane.

### Synthetic Example 3

(3-Glycidyloxypropyl)trimethoxysilane (118.15 g, 500.0 mmol) and isopropyl alcohol (240.0 g, 4000 mmol) were introduced into a 500 ml, N₂-flushed, 3-neck round bottom flask fitted with a heating mantle, magnetic stirrer, reflux condenser and thermocouple. A rubber septum was used to seal the third neck of the flask. Titanium isopropoxide (1.0 gm, 2800 ppm) was injected into the reactor through the septum. The stirred contents were heated to 70° C. and continued to reflux for 29 hours. The reaction mixture was stripped in vacuo at 85° C. to remove the unreacted isopropanol and methanol by-product. The remaining mixture was then vacuum distilled at 165° C. and 1 mbar pressure when the product (105.0 g) was obtained as clear liquid. The ²⁹Si NMR has confirmed that the product was a mixture of:
5.7 mol percent of (3-glycidyloxypropyl) trimethoxysilane
34.1 mol percent of (3 glycidyloxypropyl)dimethoxyisopropoxysilane
57 mol percent of (3-glycidyloxypropyl)methoxydiisopropoxysilane
3.2 mol percent of (3-glycidyloxypropyl)triisopropoxysilane.

### Synthetic Example 4

(3-Glycidyloxypropyl)trimethoxysilane (23.63 g, 100.0 mmol) was introduced into a 250 ml, N₂-flushed, 4-neck round bottom flask fitted with a heating mantle, magnetic stirrer, addition funnel, reflux condenser and thermocouple. A rubber septum was used to seal the fourth neck of the flask. Diazabicyclo (5.4.0) undec-7-ene (0.14 gm, 2100 ppm) was injected into the reactor through the septum. The stirred contents were heated to 65° C. The isopropyl alcohol (48.0 gm, 800 mol) taken in the additional funnel, was added in 5 consecutive portions over a period of 7 hours while maintain the reaction under a vacuum between 150-240 mbar. The reaction mixture was stripped in vacuo at 85° C. to remove the unreacted isopropanol and methanol by-product. The remaining mixture was then vacuum distilled at 165° C. and 1 mbar pressure when the product (14.0 g) was obtained as clear liquid. The ²⁹Si NMR has confirmed that the product was a mixture of:
16.2 mol percent of (3-glycidyloxypropyl)dimethoxyisopropoxysilane
75.4 mol percent of (3-glycidyloxypropyl)methoxydiisopropoxysilane
8.4 mol percent of (3-glycidyloxypropyl)triisopropoxysilane.

### Synthetic Example 5

(3-Glycidyloxypropyl)trimethoxysilane (23.63 g, 100.0 mmol) was introduced into a 250 ml, N₂-flushed, 4-neck round bottom flask fitted with a heating mantle, magnetic stirrer, addition funnel, reflux condenser and thermocouple. A rubber septum was used to seal the fourth neck of the flask. Diazabicyclo (5.4.0) undec-7-ene (0.29 gm, 2600 ppm) was injected into the reactor through the septum. The stirred contents were heated to 65° C. The isopropyl alcohol (90.0 gm, 1500 mol) taken into additional funnel, was added dropwise at rate of approximately 0.5 ml/min. over a period of 4 hours while maintain the reaction under vacuum at 250 mbar. The reaction mixture was stripped in vacuo at 85° C. to remove the unreacted isopropanol and methanol by-product. The remaining mixture was then vacuum distilled at 165° C. and 1 mbar pressure when the product (16.0 g) was obtained as clear liquid. The ²⁹Si NMR has confirmed that the product was a mixture of:
2.7 mol percent of (3-glycidyloxypropyl)dimethoxyisopropoxysilane
77.1 mol percent of (3-glycidyloxypropyl)methoxydiisopropoxysilane
20.2 mol percent of (3-glycidyloxypropyl)triisopropoxysilane.

### Synthetic Example 6

(3-Glycidyloxypropyl)trimethoxysilane (23.63 g, 100.0 mmol) and Isobutyl alcohol (59.20 g, 800 mmol) were introduced into a 250 ml, N₂-flushed, 3-neck round bottom flask fitted with a heating mantle, magnetic stirrer, reflux condenser and thermocouple. A rubber septum was used to seal the third neck of the flask. Titanium isopropoxide (0.23 gm, 2800 ppm) was injected into the reactor through septum. The stirred contents were heated to 70° C. and continued to reflux for 42 hours. The reaction temperature was lowered to 30 degree Celsius. Water (0.9 g) was added and continued to stir at 30° C. for 1 hour. The reaction mixture was stripped in vacuo at 110° C. to remove the unreacted water, isobutyl alcohol and methanol by-product. The remaining mixture was then vacuum distilled at 185° C. and 1 mbar pressure when the product (23.0 g) was obtained as clear liquid. The ²⁹Si NMR has confirmed that the product was a mixture of 12.4 mol percent of:
(3 glycidyloxypropyl)dimethoxyisobutoxysilane
45.4 mol percent of (3-glycidyloxypropyl)methoxydiisobutoxysilane
42.2 mol percent of (3-glycidyloxypropyl)triisobutoxysilane.

### Synthetic Example 7

(3-Glycidyloxypropyl)trimethoxysilane (23.63 g, 100.0 mmol) was introduced into a 250 ml, N₂-flushed, 4-neck round bottom flask fitted with a heating mantle, magnetic stirrer, addition funnel, reflux condenser and thermocouple. A rubber septum was used to seal the fourth neck of the flask. Diazabicyclo (5.4.0) undec-7-ene (0.21 gm, 1500 ppm) was injected into the reactor through the septum. The stirred contents were heated to 70° C. The isobutyl alcohol (118.5 gm, 1600 mol) taken into additional funnel, was added dropwise at rate of approximately 0.5 ml/min. over a period of 4 hours while maintain the reaction under vacuum at 110 mbar. The reaction mixture was stripped in vacuo at 110° C. to remove the unreacted isopropanol and methanol by-product. The remaining mixture was then vacuum distilled at 185° C. and 1 mbar pressure when the product (26.0 g) was obtained as clear liquid. The ²⁹Si NMR has confirmed that the product was a mixture of:
1.3 mol percent of (3 glycidyloxypropyl)dimethoxyisobutoxysilane
44.9 mol percent of (3-glycidyloxypropyl)methoxydiisobutoxysilane
53.8 mol percent of (3-glycidyloxypropyl)triisobutoxysilane.

Synthetic Example 8: The product of Synthetic Example 3 (39.38 g, 138.9 mmol) and water (1 g, 55.6 mmol) were introduced into a 100 ml, N₂-flushed, 3-neck round bottom flask fitted with a heating mantle, magnetic stirrer, reflux condenser and thermocouple. Amine catalyst (1.40 g, 35000 ppm) was added into the reactor. The stirred contents were heated to 70° C. overnight. The reaction mixture was stripped in vacuo at 100° C. to remove the unreacted isopropanol and methanol by-product. The remaining mixture was filtered under nitrogen atmosphere where the product (30.2 g) was obtained as pale yellow liquid. The ²⁹Si NMR confirms that the product is a mixture of monomers and oligomers of Synthetic Example 3.

Synthetic Example 9: A (3-glycidyloxypropyl) methoxy oligomer (80 g) and Titanium isopropoxide (0.5 g) was charged into a 3-neck round bottom flask fitted with a heating mantle, magnetic stirrer, condenser, and thermocouple at room temperature. A rubber septum was used to seal the third neck of the flask. At 125° C., Isopropyl alcohol (77.8 g) was introduced to reactor drop wise under nitrogen blanket for 4 hours. Condensate were collected into vessel during reaction. After 24 hours of reaction time, the reaction mixture was stripped in vacuo at 90° C. and 100 mbar pressure to remove the unreacted isopropanol and methanol by-product. The remaining mixture was then vacuum distilled at 120° C. and 1 mbar pressure when the product (12.0 g) was obtained as clear liquid. The ²⁹Si NMR and ¹HNMR has confirmed about 75 mole % propoxy substitution on silane Oligomer.

Synthetic Example 10: (3-Glycidyloxypropyl)trimethoxysilane (472.6 g) and Titanium isopropoxide (4 g) was charged into a 4-neck round bottom flask fitted with a heating mantle, magnetic stirrer, condenser, and thermocouple at room temperature. A rubber septum was used to seal the fourth neck of the flask. At 125° C., Isopropyl alcohol (960 g) was introduced to reactor drop wise under nitrogen blanket for 14 hours. Condensate were collected into vessel during reaction. After 24 hours of reaction time, 8 g water was added to the reaction mixture at 44° C. and stirred for 1 hour. Subsequently after 1 hour, reaction mixer was stripped in vacuo at 90° C. and 100 mbar pressure to remove the unreacted isopropanol, methanol, and other by-product. The remaining mixture was then filtered at room temperature when the product (518.92 g) was obtained as clear liquid. The ²⁹Si NMR and ¹HNMR has confirmed that the product was a mixture of:
14.28 mol percent of (3-glycidyloxypropyl)dimethoxyisopropoxysilane
50.53 mol percent of (3-glycidyloxypropyl)methoxydiisopropoxysilane
31.95 mol percent of (3-glycidyloxypropyl)triisopropoxysilane.
3.23 mol percent of oligomeric(glycidyloxypropyle)propoxymethoxysilane

Synthetic Example 11: Vinylrimethoxysilane (40.0 g) and Titanium isopropoxide (0.5 g) was charged into a 4-neck round bottom flask fitted with a heating mantle, magnetic stirrer, condenser, and thermocouple at room temperature. A rubber septum was used to seal the fourth neck of the flask. Isopropyl alcohol (132 g) was introduced to reactor under nitrogen blanket. Temperature of the reaction was raised to 95° C. and continued to stir. After 24 hours of reaction time, 0.8 g water was added to the reaction mixture at 44° C. and stirred for 1 hour. Subsequently after 1 hour, reaction mixer was stripped under low pressure at 90° C. to remove the unreacted isopropanol, methanol, and other by-products. The remaining mixture was then distilled at 115° C. and 34 mbar pressure. Final product was obtained as clear liquid. The ²⁹Si NMR has confirmed that the product was a mixture of:
11.1 mol percent of vinyldimethoxyisopropoxysilane
54.6 mol percent of vinylmethoxydiisopropoxysilane
34.3 mol percent of vinyltriisopropoxysilane.

Synthetic Example 12: Aminopropyltrimethoxy Silane (40.0 g) and Titanium isopropoxide (0.35 g) was charged into a 4-neck round bottom flask fitted with a heating mantle, magnetic stirrer, condenser, and thermocouple at room temperature. A rubber septum was used to seal the fourth neck of the flask. Isopropyl alcohol (86.73 g) was introduced to reactor under nitrogen blanket. Temperature of the reaction was raised to 100 degrees Celsius and continued to stir for 8 hours. The crude reaction mixture was collected and verified by ²⁹Si NMR which was found to be mixture of:
3.67 mol percentage (aminopropyl)trimethoxy
24.04 mol percent of (aminopropyl)dimethoxyisopropoxysilane
39.82 mol percent of (aminopropyl)methoxydiisopropoxysilane
2.01 mol percent of (aminopropyl)triisopropoxysilane.
30.46 mol percent of oligomeric(aminopropyl)propoxymethoxysilane

Synthetic Example 13: An emulsion was prepared by mixing the product obtained from synthesis example 10, surfactants and demineralised water tabulated below (Table A) using a Cowles mixer.

TABLE A
Ingredients for Synthesis example 10 emulsion

| Raw Materials | Source | Amount (g) |
|---|---|---|
| Grand 6047 (non-ionic | GRAND ORGANICS | 6 |
| surfactant, HLB~13) | PVT.LTD | |
| Product 33CH (non-ionic | Esteem Industries | 6 |
| surfactant, HLB~18) | Private Ltd | |
| DM Water (Solvent) | Momentive | 108 |
| Synthesis Example 10 | Momentive | 180 |

Particle size of the emulsion was checked by using Malvern Mastersizer 2000 and was found to be near 10.5 micron for 50% of particle's distribution.

Synthetic Example 14: A free radical emulsion polymerization of the product obtained from synthesis example 11 was performed according to a procedure described below.

TABLE B
Ingredients for emulsion polymerization of synthesis example 11

| | | | Scaled |
|---|---|---|---|
| Phase | Raw Material | Source | (g) |
| A | Water (Solvent) | Momentive | 40.48 |
| | Disponil Fes 32 (anionic surfactant) | BASF | 4.03 |
| | Potassium persulfate (KPS) (Initiator) | Sigma Aldrich | 0.31 |
| B | Water (Solvent) | Momentive | 40.00 |
| | Disponil Fes 32 (anionic surfactant) | BASF | 12.10 |
| | Methacrylic acid (MAA) (Monomer) | TCI | 1.25 |
| C | Butyl Acylate (BA) (Monomer) | Sigma Aldrich | 61.25 |
| | Methyl methacrylate (MMA) | Sigma Aldrich | 62.50 |
| | (Monomer) | | |
| | Synthesis Example 11 | Momentive | 0.63 |
| D | Water (Solvent) | Momentive | 11.36 |
| | Potassium persulfate (KPS) | Sigma Aldrich | 0.19 |
| E | Water (Solvent) | Momentive | 7.81 |
| | Tertiary butyl hydroperoxide (Initiator) | Sigma Aldrich | 0.14 |
| F | Water (Solvent) | Momentive | 7.81 |
| | Sodium formaldehydesulfoxylate | Sigma Aldrich | 0.14 |
| | (Initiator) | | |
| | Total | | 250.00 |

Monomer mixtures and radical initiator solution were prepared from the ingredient of phase A, B, C, D, E and F by mixing separately. Phase A was charged in a round bottomed flask equipped with a heating mantle, magnetic stirrer, condenser, and thermocouple at room temperature and heated at 75° C. and stirred for 15 minutes. A mechanical emulsion was separately prepared by mixing monomeric phase B and C. 5% of the mechanical emulsion was added to phase A and remaining was added linearly after 15 minutes along with phase D for 4 hours. The temperature of the reaction mixture was decreased to 40° C. and phase E and F were simultaneously added to the reaction mixture and stirred at 40° C. for 1 hour. The polymer was then neutralized to pH 8-9 with a dilute sodium hydroxide solution. The measured solid content of the emulsion polymer was found to be 48.03%.

Comparative Example 1: A silicone-free paint formula obtained from market (Asian Paints Ace Exterior Emulsion) was used as base formula 1.

Comparative Example 2: Commercially available (3-glycidyloxypropyl)trimethoxysilane was used as benchmark 1.

Comparative Example 3: A grade of commercially available (3-glycidyloxypropyl) methoxy oligomer was used as benchmark 2.

Paint Formulations:

Paint formulations were prepared with a base paint formulation and an additive selected from the present silane composition additives (e.g., from the synthetic examples) or from the comparative silanes of comparative examples 1-3. Tables 1 and 2 the composition of the respective paint formulations. Table 3 shows the percent of paint lost via scrub testing evaluated based on ASTM D2486 at 0 weeks and after two weeks using image analysis method described above.

TABLE 1

| Composition | F1 | F2 | F3 | F4 | F5 |
|---|---|---|---|---|---|
| Comparative example 1 | 99.9 | 99.9 | 99.9 | 99.9 | 99.9 |
| Synthetic example 1 | 0.1 | | | | |
| Synthetic example 2 | | 0.1 | | | |
| Synthetic example 3 | | | 0.1 | | |
| Synthetic example 4 | | | | 0.1 | |
| Synthetic example 5 | | | | | 0.1 |
| Total | 100 | 100 | 100 | 100 | 100 |

TABLE 2

| Composition | C1 | C2 | C3 |
|---|---|---|---|
| Comparative example 1 | 100 | 99.9 | 99.9 |
| Comparative example 2 | | 0.1 | |
| Comparative example 3 | | | 0.1 |
| Total | 100 | 100 | 100 |

TABLE 3

| Formula | C1 | C2 | C3 | F1 | F2 | F4 | F5 |
|---|---|---|---|---|---|---|---|
| 0-week | 100% | 12% | 12% | 13% | 51% | 42% | 53% |
| 2-week | 100% | 100% | 84% | 39% | 37% | 38% | 40% |

As shown in Table, 3, the paint formulations employing the present epoxy alkoxysilane compositions as an additive exhibit better scrub resistance and storage stability compared to the conventional silane additives.

The coating composition C4, C5, F6, and F7 were made by mixing the ingredients according to Table 4 under room temperature (25° C.) using a high-speed disperser.

TABLE 4
Coating composition containing epoxy alkoxysilanes.

| RM Description | Supplier | C4 | C5 | F6 | F7 |
|---|---|---|---|---|---|
| Water (Solvent) | | 29.45 | 29.42 | 29.42 | 29.42 |
| Alcosperse 602N | Nouryon | 0.50 | 0.50 | 0.50 | 0.50 |
| (Dispersant) | | | | | |
| Ethylan CDP 1480 | Nouryon | 0.50 | 0.50 | 0.50 | 0.50 |
| (Non-ionic Surfactant) | | | | | |
| Advantage AM-1512 | Ashland | 0.50 | 0.50 | 0.50 | 0.50 |
| (Defoamer) | | | | | |
| Dupont R-706 | Dupont | 5.00 | 5.00 | 5.00 | 5.00 |
| (Titanium dioxide) | | | | | |
| OMYACARB 2-IP | Omya | 22.00 | 21.98 | 21.98 | 21.98 |
| (Calcium carbonate) | | | | | |
| OMYACARB 5-IP | Omya | 15.50 | 15.48 | 15.48 | 15.48 |
| (Calcium carbonate) | | | | | |
| Satintone W (kaolin) | BASF | 7.00 | 6.99 | 6.99 | 6.99 |
| Talc 2 micron | 20 Micron | 8.00 | 7.99 | 7.99 | 7.99 |
| Diuron (Biocide) | Sigma- | 0.50 | 0.50 | 0.50 | 0.50 |
| | Aldrich | | | | |
| Primal AS 450 | Dow | 10.00 | 9.99 | 9.99 | 9.99 |
| (Styrene-acrylic | Chemical | | | | |
| emulsion polymer) | | | | | |
| Natrosol 250 HBR | Ashland | 0.45 | 0.45 | 0.45 | 0.45 |
| (HEC thickener) | | | | | |
| Comparative | | 0 | 0.1 | — | — |
| Example 3 | | | | | |
| Synthetic Example 9 | | 0 | — | 0.1 | — |
| Synthetic Example 10 | | 0 | — | — | 0.1 |
| AMP 95 (PH | ANGUS | 0.1 | 0.1 | 0.1 | 0.1 |
| Neutralizing agent) | Chemie | | | | |
| | GmbH | | | | |
| Texanol (Coalescing | Eastman | 0.50 | 0.50 | 0.50 | 0.50 |
| agent) | | | | | |
| Total | | 100 | 100 | 100 | 100 |

The performance evaluation of formulas C4, C5, F6, and F7 were carried out according to standard protocol described in ASTM D2486. Thus, a leneta panel was coated uniformly with each formula and dried for 7 days at room temperature. The dried panel was then tested for scrub resistance using wet abrasion scrub tester. The comparative performance is reported in terms of number of cycles for first cut throughout the film. As shown in Table 5 the formula containing the alkoxy silane of the present invention F6 and F7 exhibit better performance compared to control formulas C4 and C5.

TABLE 5
Comparative scrub resistant data for alkoxy epoxy silane.

| Formula | C4 | C5 | F6 | F7 |
|---|---|---|---|---|
| 0-week | 59 | 199 | 110 | 162 |
| 4-week | 61 | 97 | 110 | 109 |

The coating composition C6, C7, and F8 were made by mixing the ingredients according to Table 6 under room temperature (25° C.) using a high-speed disperser.

TABLE 6
Coating composition containing epoxy alkoxysilanes.

| RM Description | Supplier | C6 | C7 | F8 |
|---|---|---|---|---|
| Water (Solvent) | | 26.40 | 26.37 | 26.37 |
| alcosperse 602N (Pigment | Nouryon | 0.40 | 0.40 | 0.40 |
| Dispersant) | | | | |
| ethylan CDP 1480 (Non- | Nouryon | 0.40 | 0.40 | 0.40 |
| ionic Surfactant) | | | | |
| Advantage AM-1512 | Ashland | 0.40 | 0.40 | 0.40 |
| (Defoamer) | | | | |
| Dupont R-902 Or 706 | Dupont | 13.00 | 12.99 | 12.99 |
| (Titanium oxide) | | | | |
| OMYACARB 2-IP | Omya | 15.00 | 14.99 | 14.99 |
| (Calcium carbonate) | | | | |
| OMYACARB 5-IP | Omya | 10.00 | 9.99 | 9.99 |
| (Calcium carbonate) | | | | |
| Satintone W (kaolin) | BASF | 6.00 | 5.99 | 5.99 |
| Diuron (Biocide) | Sigma- | 0.80 | 0.80 | 0.80 |
| | Aldrich | | | |
| Primal AC 261(Acrylic | DOW | 26.00 | 25.97 | 25.97 |
| emulsion polymer) | | | | |
| Natrosol 250 HBR(HEC | Ashland | 0.50 | 0.50 | 0.50 |
| thickener) | | | | |
| Comparative Example 3 | | 0 | 0.1 | — |
| Synthetic Example 10 | | 0 | — | 0.1 |
| AMP 95 (pH | ANGUS | 0.1 | 0.1 | 0.1 |
| Neutralizing agent) | Chemie | | | |
| | GmbH | | | |
| Texanol (Coalescing | Eastman | 1 | 1 | 1 |
| agent) | | | | |
| Total | | 100 | 100 | 100 |

The performance evaluation of formula C6, C7, and F8 was carried out according to standard protocol described in ASTM D2486. Thus, a leneta panel was coated uniformly with each formula and dried for 7 days at room temperature. The dried panels were then tested for scrub resistance using a BYK wet abrasion scrub tester. The comparative performance is reported in terms of number of cycles. The higher the number of cycle, the better the performance. As shown in Table 7, formula F8 containing an alkoxy silane of the present invention exhibits better performance compared to control formulas C6 and C7.

TABLE 7
Comparative scrub resistant data for alkoxy epoxy silane.

| Formula | C6 | C7 | F8 |
|---|---|---|---|
| 0-week | 1300 | 2120 | 1970 |
| 6-week | 1270 | 1400 | 1590 |

Two part water based epoxy amine industrial coating formulation was made for performance testing of example number 10. Below is the formulation details along with description:

TABLE 8
Two part coating composition containing example 10

| Stage | Phase | Raw materials | Source | C8 | C9 | F9 |
|---|---|---|---|---|---|---|
| 1 | A | Epirez 6520-W-53 (Aqueous | Hexion | 236 | 233.64 | 233.64 |
| | | dispersion of Epoxy Resin) | | | | |
| | | Water (Solvent) | Momentive | 80 | 79.20 | 79.20 |
| | | Methoxypropanol (Co-Solvent) | Sigma- | 20 | 19.80 | 19.80 |
| | | | Aldrich | | | |
| | | Silwet L-7210 polyether- | Momentive | 0.15 | 0.15 | 0.15 |
| | | polysiloxane defoam (wetting | | | | |
| | | agent) | | | | |
| | | R960 Chemours (Titanium | Chemours | 70 | 69.30 | 69.30 |
| | | dioxide) | | | | |
| | | Heucophos schwarz (Pigment) | Heubach | 10 | 9.90 | 9.90 |
| | | Blanc Fixe (Barium sulfate) | Solvay | 70 | 69.30 | 69.30 |
| | | Talkum (Talc) | 20 micron | 35 | 34.65 | 34.65 |
| | | Heucophos CAPP | Heubach | 20 | 19.80 | 19.80 |
| | | (Anticorrosive pigment) | | | | |
| | | Micaceous iron oxide | | 20 | 19.80 | 19.80 |
| | | Tremin 238 EST 600 (calcium | Quartzwerke | 50 | 49.50 | 49.50 |
| | | silicate) | | | | |
| | | water for thinning grind | Momentive | 11.35 | 11.24 | 11.24 |
| | | (Solvent) | | | | |
| | B | Epirez 6520-W-53(Aqueous | Hexion | 150 | 148.50 | 148.50 |
| | | dispersion of Epoxy Resin) | | | | |
| | B | Synthesis Example 10 | | 0 | 0.00 | 7.72 |
| | B | Comparative Example 3 | | 0 | 7.72 | 0.00 |
| | Total epoxy part | | | 772.5 | 772.5 | 772.5 |
| 2 | C | Epikur 6870-WH-53 (AMINE | Hexion | 132 | 132 | 132 |
| | | DISPERSION) | | | | |
| | | Dowanol PPH (Co-solvent) | Dow | 31 | 31 | 31 |
| | | water for thinning (Solvent) | Momentive | 31 | 31 | 31 |
| | | Rybo 60 (Flash-rust inhibitor) | raybochemical | 1 | 1 | 1 |

| | | | |
|---|---|---|---|
| Total amine part | 195 | 195 | 195 |

Stage 1: Epoxy grind was made by using ingredients from phase A and was letdown by using phase B. Product from example 10 and Comparative Example 3 were added in coating formulation F9 and C9 in let-down phase.

Stage 2: Amino cross linker was made by using ingredients from phase C.

Finally epoxy grind and Amino-cross linker were mixed and coated on cold roll steel. Below is the application condition for above formulation:

### Application Condition

| | |
|---|---|
| Substrates: | mild CRS* |
| Preparation: | Xylene/IPA degreasing |
| Coating: | Spray application |
| DFT**: | 50-60 microns |
| Curing: | 2 weeks RT before testing |

*CRS: Cold Roll Steel
**DFT: Dry Film Thickness

Performance evaluation of formula C8, C9 and F9 were carried out by using test protocol ISO 6270-2 (Constant humidity condense water test for 24 hours and wet cross-hatch adhesion according to DIN-53151. Wet adhesion test was performed for freshly prepared sample and sample at 50° C. for 1 months. Results are tabulated (Table 9).

TABLE 9
Comparative wet adhesion data for alkoxy epoxy silane.

| Formula | C8 | C9 | F9 |
|---|---|---|---|
| 0-week | Complete | No | No |
| | Delamination | Delamination | Delamination |
| 4-week | Complete | Complete | No |
| | Delamination | Delamination | Delamination |

The foregoing description identifies various, non-limiting embodiments of a composition comprising a mixture of epoxy alkoxysilane monomers and a coating composition comprising the epoxy alkoxysilane composition as an additive therein. Modifications may occur to those skilled in the art and to those who may make and use the invention. The disclosed embodiments are merely for illustrative purposes and not intended to limit the scope of the invention or the subject matter set forth in the claims.

1. An organic functional silane composition comprising:
an organic functional alkoxy silane monomer or oligomer having one or more alkoxy groups wherein the alkoxy group contains 1-2 carbon atoms; and
an organic functional silane monomer or oligomer having one or more alkoxy groups wherein the alkoxy groups contains 3 or more carbon atoms.

2. An organic functional silane composition comprising (i) two or more organic functional silane monomers selected from monomers (a)-(d); (ii) an oligomer of one or more monomers selected from monomers (a)-(d); or (iii) a mixture of (i) and (ii), where monomers (a)-(d) are selected from:
(a) a silane of the formula (I): 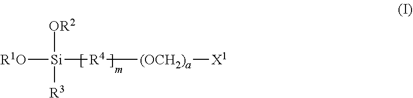
where R¹ and R² are each independently chosen from a monovalent C1-C2 hydrocarbon; R³ is a C1-C10 alkyl or —OR⁵, where R⁵ is a C1-C2 hydrocarbon; R⁴ is a C2-C60 divalent hydrocarbon;
m is an integer between 0 or 1; and a is 0 or 1;
(b) a silane of the formula (II): 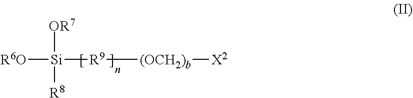
where R⁶ is chosen from a monovalent C1-C2 hydrocarbon; R⁷ is a C3-C20 monovalent hydrocarbon; R⁶ is a C1-C10 alkyl or —OR¹⁰, where R¹⁰ is a C1-C2 hydrocarbon R⁹ is a divalent C2-C60 hydrocarbon; n is an integer between 0 or 1; and b is 0 or 1;
(c) a silane of the formula (III): 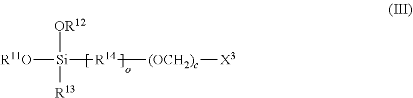
where R¹¹ and R¹² are each independently chosen from a monovalent C3-C20 hydrocarbon; R¹³ is a C1-C10 alkyl or —OR¹⁵, R¹⁵ is a monovalent C1-C2 hydrocarbon; R¹⁴ is a divalent C2-C60 hydrocarbon; o is an integer between 0 or 1; and c is 0 or 1; and
(d) a silane of the formula (IV): 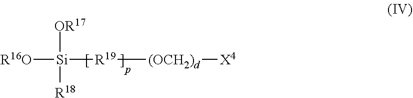
where R¹⁶, R¹⁷, and R⁸ are each independently selected from a monovalent C3-C20 hydrocarbon; R¹⁹ is selected from a divalent C2-C60 hydrocarbon; p is an integer between 0 or 1; and d is 0 or 1; and
X¹, X², X³, and X⁴ are each independently an organic functional group functional group.

3. The organic functional silane composition of claim 2, wherein the composition comprises silane (a) and silane (b) or an oligomer thereof.

4. The organic functional silane composition of claim 2, wherein the composition comprises silane (a) and silane (c) or an oligomer thereof.

5. The organic functional silane composition of claim 2, wherein the composition comprises silane (a) and silane (d) or an oligomer thereof.

6. The organic functional silane composition of claim 2, wherein the composition comprises silane (b) and silane (c) or an oligomer thereof.

7. The organic functional silane composition of claim 2, wherein the composition comprises silane (b) and silane (d) or an oligomer thereof.

8. The organic functional silane composition of claim 2, wherein the composition comprises silane (c) and silane (d) or an oligomer thereof.

9. The organic functional silane composition of claim 2, wherein the composition comprises silane (a), silane (b), and silane (c) or an oligomer thereof.

10. The organic functional silane composition of claim 2, wherein the composition comprises silane (a), silane (b), and silane (d) or an oligomer thereof.

11. The organic functional silane composition of claim 2, wherein the composition comprises silane (a), silane (c), and silane (d) or an oligomer thereof.

12. The organic functional silane composition of claim 2, wherein the composition comprises a silane (b), silane (c), and silane (d) or an oligomer thereof.

13. The organic functional silane composition of claim 2, wherein the composition comprises a mixture or oligomer of silane (a), silane (b), silane (c), and silane (d) or an oligomer thereof.

14. The organic functional silane composition of claim 2, wherein the composition is a mixture of two or more oligomers of one or more of silanes (a)-(d).

15. The organic functional silane composition of claim 2 comprising (i) one or more silanes of (a)-(d), and (ii) an oligomer of one or more of silanes (a)-(d).

16. The organic functional silane composition of claim 2, wherein R³ is —OR⁵; R⁸ is —OR¹⁰; and R¹³ is —OR¹⁵.

17. The organic functional silane composition of claim 2, wherein X¹, X², X³, and X⁴ are independently selected from an alkyl group, an aromatic group, an alicyclic group, an alkenyl group, an amino group, an acrylic, an acryloxy group, an amidegroup, a mercapto group, a cyano group, a hydroxyl group, or an epoxy group.

18. The organic functional silane composition of claim 17, wherein X¹, X², X³, and X⁴ are independently selected from an epoxy group.

19. The organic functional silane composition of claim 2, wherein X¹, X², X³, and X⁴ are independently selected from:

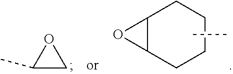

20. The organic functional silane composition of claim 17, wherein X¹, X², X³, and X⁴ are independently selected from a C2-C20 alkenyl group.

21. The organic functional silane composition of claim 20, wherein the alkenyl group is a vinyl group, and a, b, c, d, m, n, o, and p are each 0.

22. The organic functional silane composition of claim 2, where (i) X¹, X², X³, and X⁴ are each vinyl and a, b, c, d, m, n, o, and p are each 0; (ii) X¹, X², X³, and X⁴ are each amine group and m, n, o, and p are each 1, R⁴, R⁹, R¹⁴, and R¹⁹ are each a C3 hydrocarbon, and a, b, c, and d are each 0; (iii) X¹, X², X³, and X⁴ are each cyano group and m, n, o, and p are each 1, R⁴, R⁹, R¹⁴, and R¹⁹ are each a C3 hydrocarbon, and a, b, c, and d are each 0; (iv) X¹, X², X³, and X⁴ are each thiol group and m, n, o, and p are each 1, R⁴, R⁹, R¹⁴, and R¹⁹ are each a C3 hydrocarbon, and a, b, c, and d are each 0; (v) X¹, X², X³, and X⁴ are each acryloxy group and m, n, o, and p are each 1, R⁴, R⁹, R¹⁴, and R¹⁹ are each a C3 hydrocarbon, and a, b, c, and d are each 0; (vi) X¹, X², X³, and X⁴ are each acrylamido group and m, n, o, and p are each 1, R⁴, R⁹, R¹⁴, and R¹⁹ are each a C3 hydrocarbon, and a, b, c, and d are each 0.

23. A copolymer of the organic functional silane composition of claim 1 and a monomer or a functional polymer.

24. An emulsion comprising the silane composition of any of claim 1.

25. A coating, adhesive, or sealant composition comprising the silane composition of claim 2.

26. The coating, adhesive, or sealant composition of claim 25, wherein the coating, adhesive, or sealant composition consists essentially of the silane composition.

27. The coating, adhesive, or sealant composition of claim 25, wherein the coating, adhesive, or sealant composition is a waterborne composition.

28. The coating, adhesive, or sealant composition of claim 25, wherein the coating, adhesive, or sealant composition is a solvent borne composition.

29. The coating, adhesive, or sealant composition of claim 25, wherein the coating, adhesive, or sealant is an emulsion.

30. A substrate coated with the composition of claim 25.

31. A process for synthesizing an oligomer, the process comprising reacting at least two silanes selected from the group consisting of a silane having the formula (a), a silane having formula (b), a silane having formula(c), and a silane having formula (d) or their oligomers
(a) a silane of the formula (I): 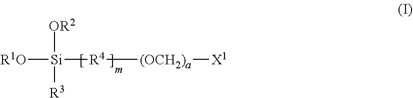
where R¹ and R² are each independently chosen from a monovalent C1-C2 hydrocarbon; R³ is a C1-C10 alkyl or —OR⁵, where R⁵ is a C1-C2 hydrocarbon; R⁴ is a C2-C60 divalent hydrocarbon;
m is an integer between 0 or 1; and a is 0 or 1;
(b) a silane of the formula (II): 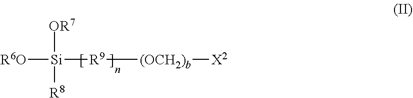
where R⁶ is chosen from a monovalent C1-C2 hydrocarbon; R⁷ is a C3-C20 monovalent hydrocarbon; R⁸ is a C1-C10 alkyl or —OR¹⁰, where R¹⁰ is a C1-C2 hydrocarbon R⁹ is a divalent C2-C60 hydrocarbon; n is an integer between 0 or 1; and b is 0 or 1;
(c) a silane of the formula (III): 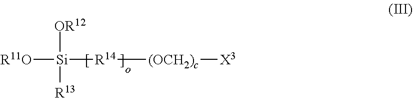
where R¹¹ and R¹² are each independently chosen from a monovalent C3-C20 hydrocarbon; R¹³ is a C1-C10 alkyl or —OR¹⁵, R¹⁵ is a monovalent C1-C2 hydrocarbon; R¹⁴ is a divalent C2-C60 hydrocarbon; o is an integer between 0 to 1; and c is 0 or 1; and
(d) a silane of the formula (IV): 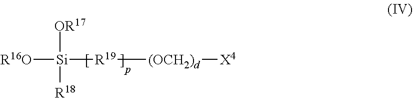
where R¹⁶, R¹⁷, and R¹⁸ are each independently selected from a monovalent C3-C20 hydrocarbon; R¹⁹ is selected from a divalent C2-C60 hydrocarbon; p is an integer between 0 to 1;
and d is 0 or 1; and
X¹, X², X³, and X⁴ are each independently selected from an alkyl group, an aromatic group, an alicyclic group, an alkenyl group, an amino group, an acrylic, an acryloxy group, an amidegroup, a mercapto group, a cyano group, a hydroxyl group, or an epoxy group.

32. An oligomer synthesized by the process as claimed in 31.

33. A composition comprising a mixture of one or more oligomers synthesized by the process as claimed in claim 31.

34. A composition comprising a mixture of at least one silane selected from the group consisting of (a)-(d) and at least one oligomer synthesized by the process as claimed in claim 31.

35. A process for coating a substrate, the process comprising applying the composition as claimed in claim 2 to at least one surface of the substrate

36. A coated substrate prepared by the process as claimed in claim 35.

37. A process for preparing a film or an article, the process comprising coalescence or contacting the composition as claimed in claim 2 with a catalyst, moisture, or a radiation.

38. A process for preparing a film or an article, the process comprising exposing the composition as claimed in claim 2 to a curing condition.

39. The process as claimed in claim 38, wherein the curing condition is a curing pH or a curing temperature.

40. A cured film or article as prepared by the process of claim 37.

41. A cured film or article formed from the composition of of claim 2.

42. A process for producing an organic functional silane composition as claimed in claim 2, the process comprising:
(a) combining a transesterification catalyst and transesterifiable alkoxysilane to provide a mixture thereof;
(b) subjecting the mixture from step (a) to transesterification reaction conditions upon addition of transesterifying alcohol thereto;
(c) adding transesterifying alcohol to the mixture of step a before and/or during step (b) to provide a transesterification reaction medium thereby commencing transesterification and producing upon such alkoxysilane transesterification reaction product;
(d) optionally deactivating the transesterification catalyst from the transesterification reaction medium to provide a catalyst-depleted transesterification reaction medium containing alkoxysilane transesterification reaction product;
(e) optionally removing byproduct alcohol formed during transesterification from the transesterfication reaction medium; and
(f) optionally separating alkoxysilane transesterification reaction product from the transesterification catalyst-depleted transesterification reaction medium of step (d).
